(19) United States
(12) Patent Application Publication
(10) Pub. No.: US 2026/0292885 A1
(43) Pub. Date: Sep. 24, 2026

(54) RANDOM ACCESS BASED ON DECOUPLED DOWNLINK/UPLINK TRANSMISSION RECEPTION POINTS

(71) Applicant: InterDigital Patent Holdings, Inc., Wilmington, DE (US)

(72) Inventors: Jonghyun Park, Syosset, NY (US); Moon IL Lee, Melville, NY (US); Nazli Khan Beigi, Longueuil (CA); Jongwoo Hong, New York, NY (US); Virgile Garcia, Antibes (FR)

(73) Assignee: InterDigital Patent Holdings, Inc., Wilmington, DE (US)

(21) Appl. No.: 19/088,363

(22) Filed: Mar. 24, 2025

(51) Int. Cl. H04W 74/0833

(52) U.S. Cl. CPC H04W 74/0833

(57) ABSTRACT

A wireless transmit/receive unit (WTRU) may receive a first synchronization signal block (SSB) from a first transmission reception point (TRP). The WTRU may receive configuration information associated with the first TRP. The configuration information may indicate pre-associations between a plurality of first SSBs associated with the first TRP and a plurality of second SSBs associated with a random access procedure. The WTRU may determine to use one or more SSBs of the plurality of second SSBs for the random access procedure based on the pre-associations. The WTRU may send a random access message to a second TRP using a second SSB of the determined one or more SSBs. The WTRU may receive a random access response (RAR) message from the first TRP that indicates a scheduling grant for a physical uplink shared channel (PUSCH) transmission.

### BACKGROUND

Duplexing technologies have been investigated to improve conventional time division duplex (TDD) operation by enhancing uplink (UL) coverage, improving capacity, reducing latency, and so forth. The conventional TDD operation is based on splitting the time domain between the uplink and downlink. The feasibility of allowing full duplex, or more specifically, subband non-overlapping full duplex (SBFD) at the gNB within a conventional TDD band has been investigated.

The realization of SBFD is subject to resolving the key challenges raised due to cross-link interferences (CLI). In an SBFD (or dynamic/flexible TDD) framework, a potential aggressor cell may switch from UL to downlink (DL) or vice-versa, causing CLI on potential victim gNBs and wireless transmit/receive units (WTRUs). In UL-to-DL CLI, the UL transmission from aggressor WTRUs may cause directional CLI at the victim WTRUs. The CLI can be measured at the victim and/or the aggressor WTRUs.

### SUMMARY

Methods and apparatuses may be described herein for random access based on decoupled downlink/uplink (DL/UL) transmission reception points (TRPs) and/or subband non-overlapping full duplex (SBFD) operation. Methods and apparatuses may be described herein for pre-associations between a first synchronization signal block (SSB) (e.g., from a first TRP) and one or more second SSBs (e.g., for a second TRP) with corresponding random access channel (RACH) occasions (ROs). Methods and apparatuses may be described herein for a zone-based RO selection. Methods and apparatuses may be described herein for wireless transmit/receive unit (WTRU) beam sweeping based on associations between a first SSB (e.g., transmitted by the first TRP) and a set of ROs.

A WTRU may receive a first SSB from a first TRP. The WTRU may receive configuration information associated with the first TRP. The configuration information may indicate pre-associations between a plurality of first SSBs associated with the first TRP and a plurality of second SSBs associated with a random access procedure. The WTRU may determine to use one or more SSBs of the plurality of second SSBs for the random access procedure based on the pre-associations. The WTRU may send a random access message to a second TRP using a second SSB of the determined one or more SSBs. The WTRU may receive a random access response (RAR) message from the first TRP that indicates a scheduling grant for a physical uplink shared channel (PUSCH) transmission.

The configuration information may further indicate mapping information between the plurality of second SSBs and respective pathloss (PL) offset parameters associated with sending the random access message. The WTRU may determine a transmit power level for the random access message based on a PL offset associated with the second SSB. The configuration information may further indicate mapping information between the plurality of second SSBs and respective ROs. The WTRU may determine a first spatial-domain filter associated with reception of the first SSB. The WTRU may determine a second spatial-domain filter associated with sending the second SSB. The pre-associations may include a pre-association between the first SSB and one or more of the plurality of second SSBs. The configuration information may be received from the first TRP via a system information block (SIB). The configuration information may include first time and frequency location information on one or more downlink subbands in one or more SBFD slots or time and frequency location information associated with one or more uplink subbands in the one or more SBFD slots. The random access message may be sent using a plurality of second SSBs on a plurality of uplink beams with respective directions that are proximate to a direction of the downlink beam associated with the first SSB. The RAR message may indicate a selection of one of the plurality of uplink beams to use for the PUSCH transmission.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example subband non-overlapping full duplex (SBFD) configuration in a time division duplex (TDD) framework.

FIG. 3 is a diagram illustrating an example cross-link interference among gNBs and WTRUs.

FIGS. 4A and 4B are diagrams illustrating example asymmetric downlink/uplink (DL/UL) transmission reception points (TRPs).

FIG. 5 is a diagram illustrating an example downlink control information (DCI) field (e.g., transmission configuration indicator (TCI) field) of a DCI for unified TCI-state indications.

FIG. 6 is a diagram illustrating an example TCI or beam control across SBFD and non-SBFD symbols.

FIG. 7 is a diagram illustrating example associations between a first synchronization signal block (SSB) and one or more second SSBs.

FIG. 8 is a diagram illustrating an example SSB to random access channel (RACH) occasion (RO) mapping with ascending order of SSB indexes in ROs.

FIG. 9 is a diagram illustrating example associations between a first SSB and one or more second SSBs in an SBFD system.

FIG. 10 is a diagram illustrating an example WTRU beam sweeping based on associations between an SSB and a set of ROs.

### DETAILED DESCRIPTION

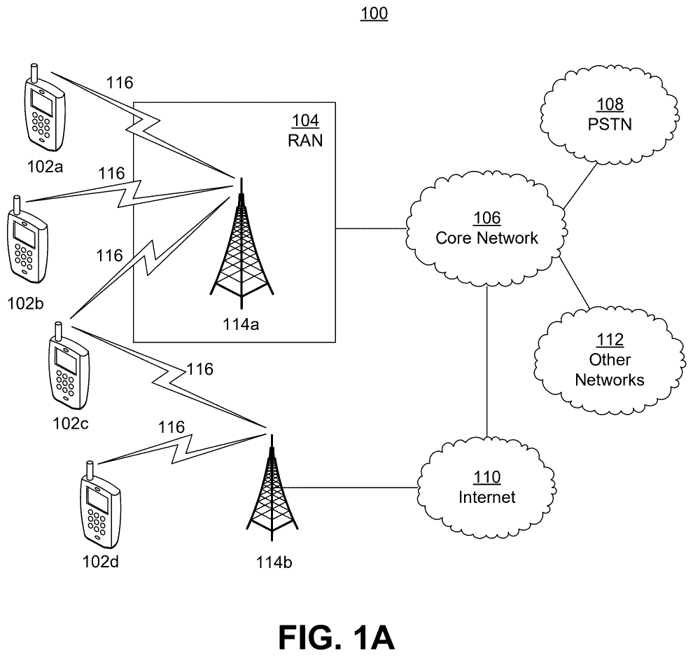

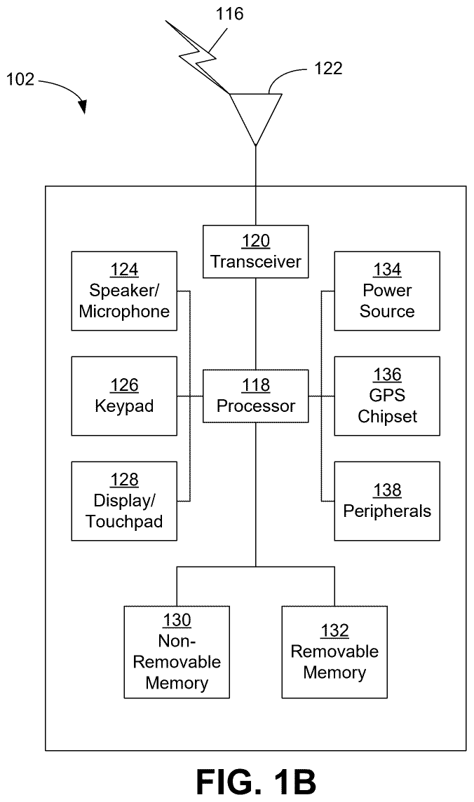

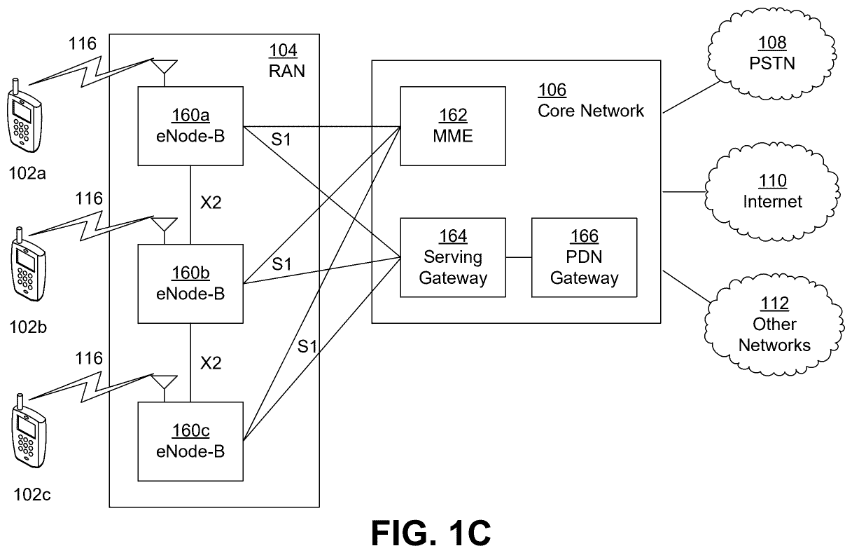

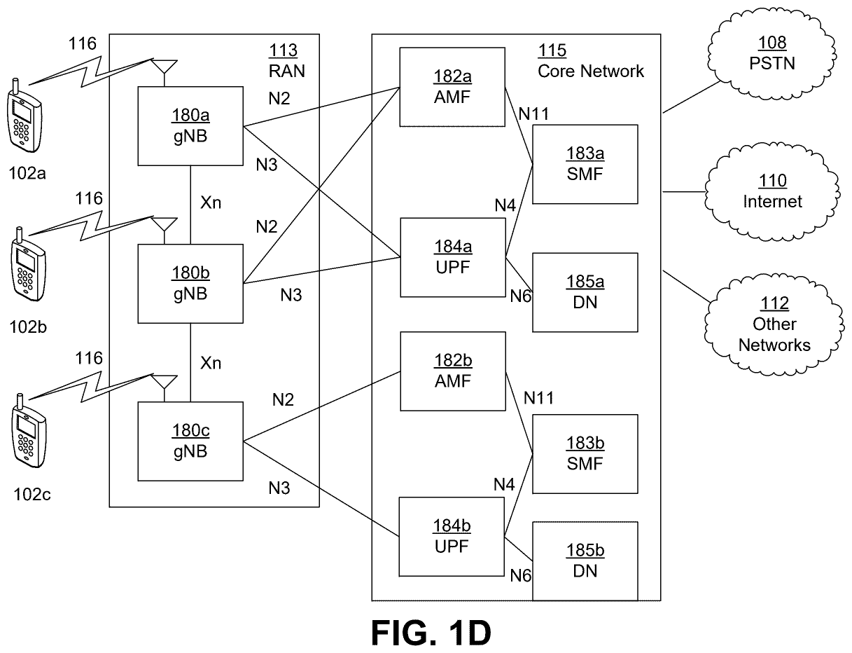

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, e.g., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (e.g., Wireless Fidelity (WiFi), IEEE 802.16 (e.g., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

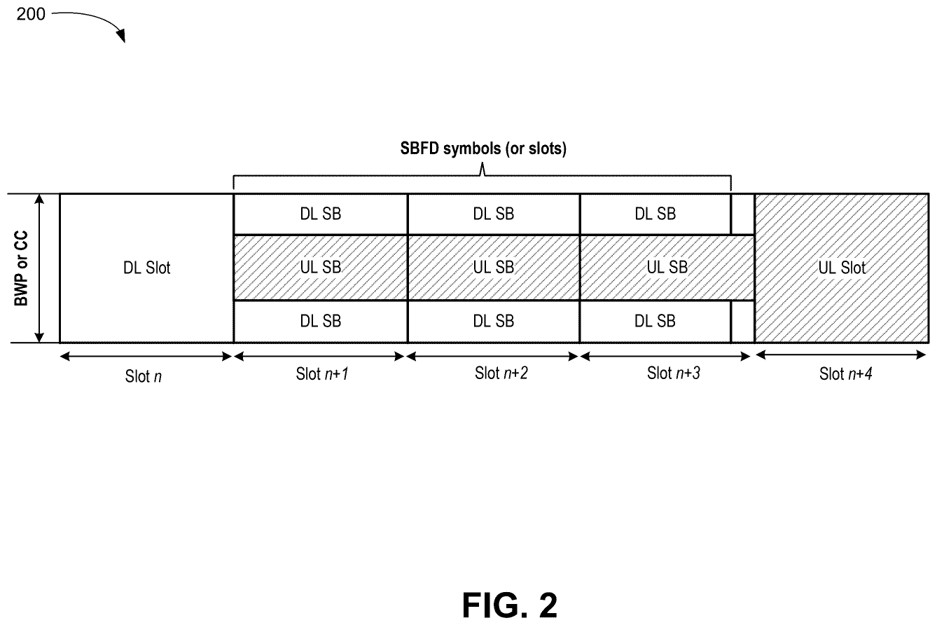

In 5G wireless systems, duplexing technologies have been investigated based on a RAN work item on New Radio (NR) duplex operation, to improve conventional TDD operation by enhancing UL coverage, improving capacity, reducing latency, and so forth. The conventional TDD is based on splitting the time domain between the uplink and downlink. In NR Rel-19, the feasibility of allowing full duplex, or more specifically, subband non-overlapping full duplex (SBFD) at the gNB within a conventional TDD band is investigated. FIG. 2 is a diagram illustrating an example subband non-overlapping full duplex (SBFD) configuration 200 in a time division duplex (TDD) framework.

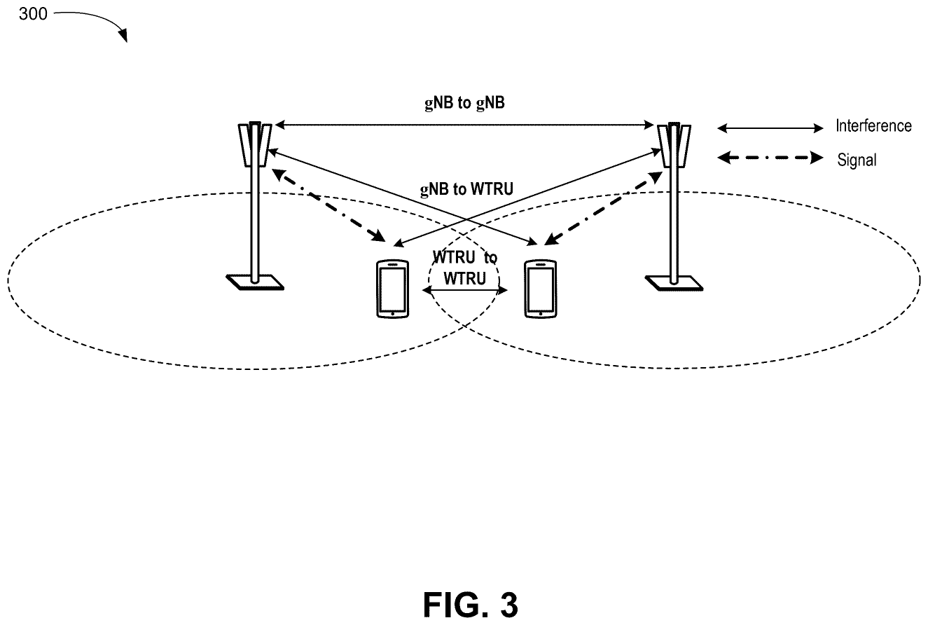

The realization of SBFD is subject to resolving the key challenges raised due to cross-link interferences (CLI). In an SBFD (or dynamic/flexible TDD) framework, a potential aggressor cell may switch from UL to DL or vice-versa, causing CLI on potential victim gNBs and WTRUs. In UL-to-DL CLI, the UL transmission from aggressor WTRUs may cause directional CLI at the victim WTRUs. FIG. 3 is a diagram illustrating an example cross-link interference 300 among gNBs and WTRUs. The CLI may be measured at both the victim and/or aggressor WTRUs.

In NR Rel-19, a special case of multi-point deployment is considered where unlike conventional systems, uplink and downlink transmissions are asymmetric (e.g., decoupled). In this deployment scenario, two different types of TRPs may be assumed, e.g., conventional TRPs with UL/DL capabilities and UL (e.g., UL-only) TRPs that are capable of (e.g., only capable of) reception of uplink signals. As such, no change of existing cell definition or defining may be required.

Since in such deployment, there may be no downlink transmission of any form from a UL (e.g., UL-only) cell, all DL transmissions may be strictly from the main TRP. A typical deployment may include at least one TRP with both downlink and uplink transmission capabilities, and at least one receive-only point (ROP).

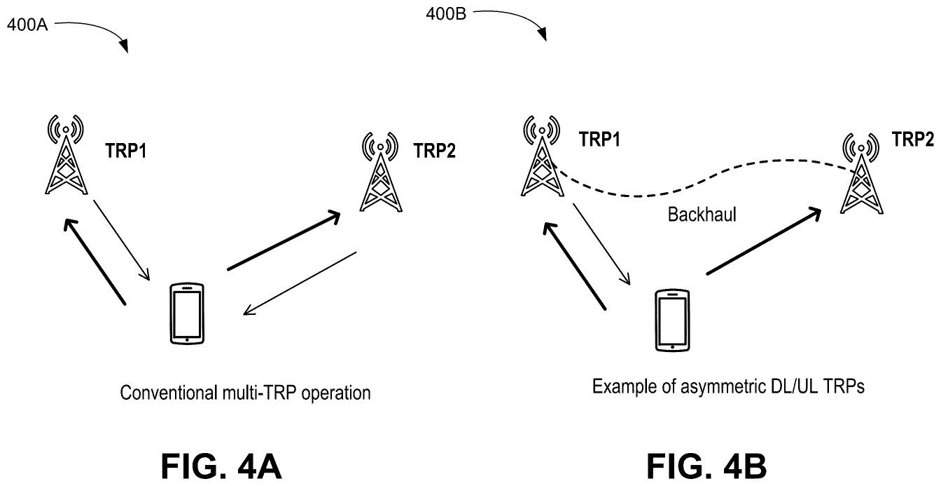

FIGS. 4A and 4B show two different deployments 400A, 400B based on conventional and UL-only TRP. In FIG. 4B, a UL (e.g., UL-only) TRP, e.g., the ROP (e.g., TRP2), may be connected to the main TRP (e.g., TRP1) by a backhaul connection (e.g., via an (almost) ideal backhaul, e.g., based on optical fiber, wired connection). Once an ROP receives an uplink signal, after some basic initial processing, it may share the signal for further processing to the main TRP.

The main benefit of ROP deployment is to improve uplink throughput, coverage, and reliability performance for cell edge WTRUs by mitigating limitations due to large pathloss and WTRU transmission power.

The multi-TRP deployment may comprise a first TRP for DL transmissions (e.g., only DL transmissions) and a second TRP for UL receptions (e.g., only UL receptions), where such first and second TRPs (e.g., being connected via an (almost) ideal backhaul, e.g., based on optical fiber, etc.) may be regarded as “decoupled TRPs” in terms of DL and UL each served by a different TRP. This deployment scenario of decoupled TRPs, e.g., when combined with a duplex operation such as SBFD, may provide energy saving gains, reduce deployment cost, and/or facilitate such deployments thanks to significantly reduced downlink interference (e.g., self-interference affecting UL receptions, e.g., at the second TRP).

In a decoupled DL/UL-TRP (e.g., asymmetric TRP) scenario, when an SSB is detected that is transmitted from a DL-TRP1, a WTRU may determine a proper RACH occasion (RO) toward a UL-TRP2 on which the WTRU transmits a PRACH.

The WTRU may be configured with pre-associations between a first SSB (from DL-TRP1) and one or more second SSBs (for UL-TRP2) with corresponding ROs.

The WTRU may detects a first SSB (e.g., SSB #2). For example, the WTRU may receive the first SSB from a first TRP. The WTRU may determine a first spatial-domain filter being used for reception of the first SSB.

The WTRU may receive configuration information (e.g., via system information based on the detected SSB) associated with the first TRP. The configuration information may include (e.g., the configuration information may indicate) one or more of the following. The configuration information may include a plurality of synchronization signal block (SSB) indexes, e.g., via system information, of a cell. The configuration information may include a plurality of pathloss(PL)-offset parameters (e.g., values in dB), e.g., PL-offset #1, 2, 3, 4, 5, 6, etc. The configuration information may include pre-associations between a plurality of first SSBs associated with the first TRP and a plurality of second SSBs associated with a random access procedure. For example, the pre-associations (e.g., signaled by SIB) may be between SSBs (of the plurality of SSBs) to be applied for a random access procedure, e.g., determining one or more RACH occasions (ROs) to transmit a PRACH upon detecting an SSB. The pre-associations may include a first SSB index, e.g., SSB #2 (transmitted from DL-TRP1) and one or more second SSB indexes. For example, SSB #4 (representing a geographically-separated UL-TRP2), where each of the one or more second SSB indexes may be mapped to a separate RO. The pre-associations may include a third SSB index, e.g., SSB #1 (transmitted from DL-TRP1) and one or more fourth SSB indexes, e.g., SSB #2, 3, 11, 12 (for UL-TRP2), where each of the one or more fourth SSB indexes may be mapped to a separate RO.

The configuration information may include mapping information between an SSB and a PL-offset. Each of the one or more second (or fourth) SSB indexes may be associated with (e.g., linked to, mapped to) a corresponding PL offset which is used for determining a PRACH power (e.g., in consideration of a proper Tx power level determination for the geographically-separated UL-TRP2). For example, each of the one or more second (or fourth) SSBs may further have its association to a PL-offset, e.g., SSB #4 may be associated with PL-offset #1, SSB #2 may be associated with PL-offset #5, SSB #3 may be associated with PL-offset #6, SSB #11, 12 may be (commonly) associated with PL-offset #9.

The configuration information may include mapping information between the plurality of second SSBs and respective ROs. For example, the configuration information may include information related to an SSB-to-RO mapping rule, e.g., SSB #1 maps to RO #1, SSB #2 maps to RO #2, etc. Each RO may represent a time and frequency location of the RO over which the WTRU may transmit a PRACH. The resulting number of ROs (e.g., 96) may be larger than the number of SSBs (e.g., 64). The configuration information may include first time and frequency location information on one or more downlink subbands in one or more SBFD slots or time and frequency location information associated with one or more uplink subbands in the one or more SBFD slots.

The WTRU may determine to use one or more of the plurality of second SSBs for a random access procedure based on the pre-associations. For example, the WTRU may determine, based on the pre-associations, the one or more second SSB indexes (e.g., SSB #4) being associated with the detected first SSB index. The WTRU may determine a second spatial-domain (e.g., Rx and/or Tx) filter associated with (e.g., being used for receiving) the SSB #4 and a Tx power level based on the PL-offset #1 associated with SSB #4. For example, the WTRU may determine a transmit power level for the random access message based on a PL offset associated with the second SSB. The WTRU may determine a corresponding RO index (e.g., RO #4) mapped to the second SSB (e.g., the determined SSB #4).

The WTRU may send a random access message (e.g., PRACH message) to a second TRP using the second SSB (e.g., the determined SSB #4). For example, the WTRU, in response to detecting the SSB #2, may send a PRACH (e.g., Msg1, toward the UL-TRP2) by using the determined Tx power level and/or the second spatial-domain filter (e.g., determined based on SSB #4) and on the determined RO (RO #4). The WTRU may perform a beam sweep (e.g., around the first SSB) to determine which of a plurality of second SSBs to use to send an uplink transmission (e.g., a PUSCH transmission). For example, the WTRU may send the random access message using a plurality of second SSBs on a plurality of uplink beams with respective directions that are proximate to a direction of the downlink beam associated with the first SSB.

The WTRU may receive a random-access response (RAR) (e.g., Msg2) transmitted from the first TRP (e.g., the DL-TRP1), for example, using the first spatial-domain filter. The RAR may comprise a scheduling grant for a PUSCH transmission, e.g., to be transmitted by using the second spatial-domain filter. The RAR message may indicate a selection of one of the plurality of uplink beams to use for the PUSCH transmission.

Hereinafter, ‘a’ and ‘an’ and similar phrases may be interpreted as ‘one or more’ and ‘at least one’. Similarly, any term which ends with the suffix ‘(s)’ may be interpreted as ‘one or more’and ‘at least one’. The term ‘may’is to be interpreted as ‘may, for example’.

A symbol ‘/’ (e.g., forward slash) may be used herein to represent ‘and/or’, where for example, ‘A/B’may imply ‘A and/or B’.

Hereinafter, the term “subband” may be used to refer to a frequency-domain resource and may be characterized by at least one of the following: a set of resource blocks (RBs); a set of resource block sets (RB sets), e.g. when a carrier has intra-cell guard bands; a set of interlaced resource blocks; a bandwidth part, or portion thereof; or a carrier, or portion thereof.

For example, a subband may be characterized by a starting RB and number of RBs for a set of contiguous RBs within a bandwidth part. A subband may also be defined by the value of a frequency-domain resource allocation field and bandwidth part index.

Hereinafter, the term “XDD” may be used to refer to a subband-wise duplex (e.g., either UL or DL being used per subband) and may be characterized by at least one of the following: Cross Division Duplex (e.g., subband-wise FDD within a TDD band); Subband-based full duplex (e.g., full duplex as both UL and DL are used/mixed on a symbol/slot, but either UL or DL being used per subband on the symbol/slot); Frequency-domain multiplexing (FDM) of DL/UL transmissions within a TDD spectrum; a subband non-overlapping full duplex (SBFD) (e.g., non-overlapped sub-band full-duplex), a full duplex other than a same-frequency (e.g., spectrum sharing, subband-wise-overlapped) full duplex; or an advanced duplex method, e.g., other than (pure) TDD or FDD.

Hereinafter, the term “dynamic(/flexible) TDD” may be used to refer to a TDD system/cell which may dynamically (and/or flexibly) change/adjust/switch a communication direction (e.g., a downlink, an uplink, or a sidelink, etc.) on a time instance (e.g., slot, symbol, subframe, and/or the like). In an example, In a system employing dynamic/flexible TDD, a component carrier(CC) or a bandwidth part (BWP) may have one single type among ‘D’, ‘U’, and ‘F’ on a symbol/slot, based on an indication by a group-common(GC)-DCI (e.g., format 2_0) comprising a slot format indicator (SFI), and/or based on tdd-UL-DL-config-common/dedicated configurations. On a given time instance/slot/symbol, a first gNB (e.g., cell, TRP) employing dynamic/flexible TDD may transmit a downlink signal to a first WTRU being communicated/associated with the first gNB based on a first SFI and/or tdd-UL-DL-config configured/indicated by the first gNB, and a second gNB (e.g., cell, TRP) employing dynamic/flexible TDD may receive an uplink signal transmitted from a second WTRU being communicated/associated with the second gNB based on a second SFI and/or tdd-UL-DL-config configured/indicated by the second gNB. In an example, the first WTRU may determine that the reception of the downlink signal is being interfered by the uplink signal, where the interference caused by the uplink signal may refer to a WTRU-to-WTRU cross-link interference (CLI).

A WTRU may transmit or receive a physical channel or reference signal according to at least one spatial domain filter. The term “beam” may be used to refer to a spatial domain filter.

The WTRU may transmit a physical channel or signal using the same spatial domain filter as the spatial domain filter used for receiving an RS (such as CSI-RS) or a SS block. The WTRU transmission may be referred to as “target”, and the received RS or SS block may be referred to as “reference” or “source”. In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal.

A spatial relation may be implicit, configured by RRC or signaled by MAC CE or DCI. For example, a WTRU may implicitly transmit PUSCH and DM-RS of PUSCH according to the same spatial domain filter as an SRS indicated by an SRS resource indicator (SRI) indicated in DCI or configured by RRC. In another example, a spatial relation may be configured by RRC for an SRI or signaled by MAC CE for a PUCCH. Such spatial relation may also be referred to as a “beam indication”.

The WTRU may receive a first (target) downlink channel or signal according to the same spatial domain filter or spatial reception parameter as a second (reference) downlink channel or signal. For example, such association may exist between a physical channel such as PDCCH or PDSCH and its respective DM-RS. At least when the first and second signals are reference signals, such association may exist when the WTRU is configured with a quasi-colocation (QCL) assumption type D between corresponding antenna ports. Such association may be configured as a transmission configuration indicator (TCI) state. A WTRU may be indicated an association between a CSI-RS or SS block and a DM-RS by an index to a set of TCI states configured by RRC and/or signaled by MAC CE. Such indication may also be referred to as a “beam indication”.

A WTRU may receive transmit configuration indication(TCI) related configuration(s), e.g., comprising a plurality of TCI-states (e.g., an RRC-configured pool of TCI-states (e.g., as unified TCI framework), ‘TCI-State’ IE, ‘TCI-UL-State’ IE, ‘spatialRelationInfo’ IE, etc.). A TCI-state of the plurality of TCI-states may be associated (comprised) with at least one of QCL-info #1, QCL-info #2, additionalPCI, pathloss RS(PLRS)-ID, UL-PC, Timing Advance Group (TAG)-ID, where QCL-info #1 (or QCL-info #2) may comprise a cell-ID (e.g., serving-cell index), a BWP-ID, a RS (e.g., CSI-RS, SSB-index), and/or a QCL-type which may be one of typeA, typeB, typeC, typeD. In an example, the PLRS-ID may be for pathloss estimation for determining a UL transmission power when a UL transmission is based on a TCI-state that is associated with the PLRS-ID. In an example, the UL-PC (e.g., UL-PC parameter set, which may comprise at least one of P0, alpha, close-loop(CL)-index, power offset, etc.) may be for determining an uplink power for an UL transmission associated with the TCI-state. In an example, the additionalPCI may be a physical cell-ID (PCID) of a neighboring (surrounding) cell that the RS (associated with the TCI-state), e.g., SSB-index (or CSI-RS) may be transmitted from, e.g., as an inter-cell beam (or RS) reference. In an example, the WTRU may apply a timing advance value (e.g., based on received timing advance command(TAC)(s)) in association with the TAG-ID (e.g., of multiple TAG-IDs being configured) to a scheduled UL transmission. A typeA QCL-type may represent {Doppler shift, Doppler spread, average delay, delay spread}. A typeB QCL-type may represent {Doppler shift, Doppler spread}. A typeC QCL-type may represent {Doppler shift, average delay}. A typeD QCL-type may represent {Spatial Rx parameter}.

When a WTRU receives an indication or configuration of a TCI-state (e.g., applicable for a physical channel or signal) at least comprising a QCL-type (e.g., by typeA, typeB, typeC, or typeD) and an RS (e.g., an RS associated with the QCL-type), the WTRU may determine (e.g., derive) at least one parameter for transmission and/or reception, representing wireless channel characteristics (e.g., at least one of Doppler shift, Doppler spread, average delay, delay spread, Spatial Rx parameter) based on the indicated QCL-type, and apply the at least one parameter for transmission or reception of the physical channel or signal.

A unified TCI (e.g., a common TCI, a common beam, a common RS, etc.) may refer to a beam/RS to be (simultaneously) used for multiple physical channels/signals. The term “TCI” may at least comprise a TCI state that includes at least one source RS to provide a reference (e.g., WTRU assumption) for determining QCL and/or spatial filter.

In an example, a WTRU may receive (e.g., from a gNB) an indication of a first unified TCI to be used/applied for both a downlink control channel (PDCCH) and a downlink shared channel (PDSCH) (e.g., and a downlink RS). The source reference signal(s) in the first unified TCI may provide common QCL information at least for WTRU-dedicated reception on the PDSCH and one or more (e.g., all or a subset of) CORESETs in a CC. In an example, a WTRU may receive (e.g., from a gNB) an indication of a second unified TCI to be used/applied for both an uplink control channel (PUCCH) and an uplink shared channel (PUSCH) (e.g., and an uplink RS). The source reference signal(s) in the second unified TCI may provide a reference for determining common UL TX spatial filter(s) at least for dynamic-grant/configured-grant based PUSCH and one or more (e.g., all or a subset of) dedicated PUCCH resources in a CC.

The WTRU may be configured with a first mode for unified TCI (e.g., SeparateDLULTCI mode, a parameter of ‘unifiedTCI-StateType’ set to ‘separate’) where an indicated unified TCI (e.g., the first unified TCI or the second unified TCI) may be applicable for either downlink (e.g., based on the first unified TCI) or uplink (e.g., based on the second unified TCI).

In an example, a WTRU may receive (e.g., from a base station(BS), a gNB, a TRP, etc.) an indication of a second unified TCI to be used/applied commonly for a PDCCH, a PDSCH, a PUCCH, and a PUSCH (and a DL RS and/or a UL RS).

The WTRU may be configured with a second mode for unified TCI (e.g., JointTCI mode, a parameter of ‘unifiedTCI-StateType’ set to ‘joint’) where an indicated unified TCI (e.g., the third unified TCI) may be applicable for both downlink and uplink (e.g., based on the third unified TCI).

The WTRU may determine a TCI state applicable to a transmission or reception by first determining a Unified TCI state instance (e.g., TCI-state group, a group of TCI-states, a set of activated TCI-states) applicable to this transmission or reception, then determining a TCI state corresponding to the Unified TCI state instance. A transmission may include at least a PUCCH, a PUSCH, and/or a SRS. A reception may include at least a PDCCH, a PDSCH, and/or a CSI-RS. A Unified TCI state instance may also be referred to TCI state group, TCI state process, unified TCI pool, a group of TCI states, a set of time-domain instances/stamps/slots/symbols, and/or a set of frequency-domain instances/RBs/subbands, etc. A Unified TCI state instance may be equivalent or identified to a Coreset Pool identity (e.g., CORESETPoolIndex, a TRP indicator, and/or the like).

Hereafter, unified TCI may be interchangeably used with one or more of unified TCI-states, unified TCI instance, TCI, and TCI-state, but still consistent with this invention.

A WTRU may be configured with a plurality of transmission configuration indicator (TCI) states, e.g., unified TCI (UTCI) states, each applicable for multiple channel(s)/signal(s). The multiple channel(s)/signal(s) may be configured to the WTRU (or pre-determined or defined), e.g., in a form of a list, by a higher-layer signaling (e.g., RRC and/or MAC-CE) which may comprise at least one of following (e.g., as a combination): one or more CORESETs; one or more PDCCH candidates; one or more search spaces; one or more PDSCHs (e.g., PDSCH occasions/configurations/instances, etc.); one or more RSs (e.g., CSI-RSs, DMRSs, SSB indexes, PRSs, PTRSs, and/or SRSs); one or more PUSCHs (e.g., PUSCH occasions/configurations/instances, etc.); one or more PUCCH resources (e.g., PUCCH resource sets/groups); or one or more PRACH occasions/resources/RSs.

The plurality of TCI states may be configured via an RRC signaling (e.g., and/or via a MAC-CE signaling, indication or activation). The WTRU may receive, e.g., via the MAC-CE or a separate signaling, an information content comprising mapping between one or more codepoints of a DCI field (e.g., TCI field, and/or TCI selection field) and at least one TCI state of the plurality of TCI states. The WTRU may receive a DCI comprising the DCI field. The WTRU may be indicated with one or more TCI states, of the plurality of TCI states, mapped to a codepoint of the one or more codepoints of the DCI field, where each of the one or more TCI states is applicable after a time duration determined based on a beam application time (BAT) parameter.

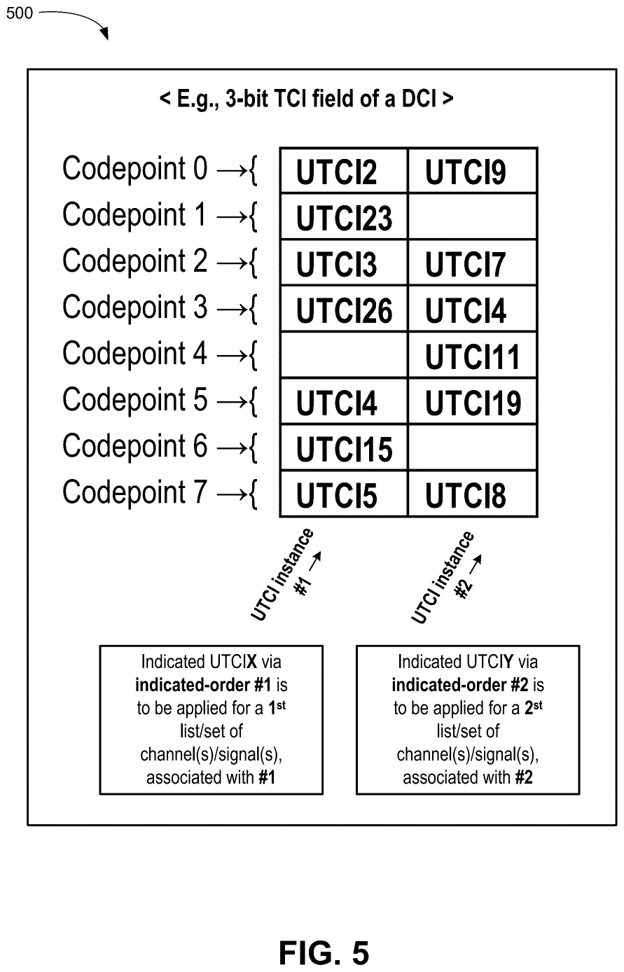

FIG. 5 depicts an example of the DCI field 500 (e.g., TCI field) of a DCI for unified TCI-state indications. The WTRU may receive the mapping between a codepoint (of the DCI field) and one or more TCI states, illustrated in the figure, e.g., via a MAC-CE signaling. For example, Codepoint 2 is mapped to {UTCI3, UTCI7}, where the WTRU may apply at least one of {UTCI3, UTCI7} to the multiple channel(s)/signal(s), e.g., based on a list of the multiple channel(s)/signal(s) configurable by a higher-layer signaling from a gNB. In an example, the list of the multiple channel(s)/signal(s) may be given per UTCI instance (e.g., TCI-state group, a group of TCI-states, a set of activated TCI-states), where the UTCI instance may correspond to each column of the mapping table, illustrated in the figure, between a codepoint and the one or more TCI states.

Hereafter, a TRP (e.g., transmission and reception point) may be interchangeably used with one or more of TP (transmission point), RP (reception point), RRH (radio remote head), DA (distributed antenna), BS (base station), a sector (of a BS), and a cell (e.g., a geographical cell area served by a BS), but still consistent with this invention. Hereafter, Multi-TRP may be interchangeably used with one or more of MTRP, M-TRP, and multiple TRPs, but still consistent with this invention.

A WTRU may report a subset of channel state information (CSI) components, where CSI components may correspond to at least a CSI-RS resource indicator (CRI), a SSB resource indicator (SSBRI), an indication of a panel used for reception at the WTRU (such as a panel identity or group identity), measurements such as L1-RSRP, L1-SINR taken from SSB or CSI-RS (e.g. cri-RSRP, cri-SINR, ssb-Index-RSRP, ssb-Index-SINR), and other channel state information such as at least rank indicator (RI), channel quality indicator (CQI), precoding matrix indicator (PMI), Layer Index (LI), and/or the like.

A WTRU may receive a synchronization signal/physical broadcast channel (SS/PBCH) block. The SS/PBCH block (SSB) may include a primary synchronization signal (PSS), secondary synchronization signal (SSS), and physical broadcast channel (PBCH). The WTRU may monitor, receive, or attempt to decode an SSB during initial access, initial synchronization, radio link monitoring (RLM), cell search, cell switching, and so forth.

A WTRU may measure and report the channel state information (CSI), wherein the CSI for each connection mode may include or be configured with one or more of following: a CSI Report Configuration, a CSI RS Resource Set, or NZP CSI-RS Resources. The CSI Report Configuration may include one or more of the following: a CSI report quantity (e.g., Channel Quality Indicator (CQI), Rank Indicator (RI), Precoding Matrix Indicator (PMI), CSI-RS Resource Indicator (CRI), Layer Indicator (LI), etc.); a CSI report type (e.g., aperiodic, semi persistent, periodic); a CSI report codebook configuration (e.g., Type I, Type II, Type II port selection, etc.); or a CSI report frequency.

The CSI-RS Resource Set may include one or more of the following CSI Resource settings: a NZP-CSI-RS Resource for channel measurement, a NZP-CSI-RS Resource for interference measurement, or a CSI-IM Resource for interference measurement.

The NZP CSI-RS Resources may include one or more of the following: a NZP CSI-RS Resource ID, a periodicity, an offset, QCL Info, TCI-state, or one or more resource mappings (e.g., number of ports, density, CDM type, etc.).

A WTRU may indicate, determine, or be configured with one or more reference signals. The WTRU may monitor, receive, and measure one or more parameters based on the respective reference signals. For example, one or more of the following may apply. The following parameters are non-limiting examples of the parameters that may be included in reference signal(s) measurements. One or more of these parameters may be included. Other parameters may be included.

SS reference signal received power (SS-RSRP) may be measured based on the synchronization signals (e.g., demodulation reference signal (DMRS) in PBCH or SSS). It may be defined as the linear average over the power contribution of the resource elements (RE) that carry the respective synchronization signal. In measuring the RSRP, power scaling for the reference signals may be required. In case SS-RSRP is used for L1-RSRP, the measurement may be accomplished based on CSI reference signals in addition to the synchronization signals.

CSI-RSRP may be measured based on the linear average over the power contribution of the resource elements (RE) that carry the respective CSI-RS. The CSI-RSRP measurement may be configured within measurement resources for the configured CSI-RS occasions.

SS signal-to-noise and interference ration (SS-SINR) may be measured based on the synchronization signals (e.g., DMRS in PBCH or SSS). It may be defined as the linear average over the power contribution of the resource elements (RE) that carry the respective synchronization signal divided by the linear average of the noise and interference power contribution. In case SS-SINR is used for L1-SINR, the noise and interference power measurement may be accomplished based on resources configured by higher layers.

CSI-SINR may be measured based on the linear average over the power contribution of the resource elements (RE) that carry the respective CSI-RS divided by the linear average of the noise and interference power contribution. In case CSI-SINR is used for L1-SINR, the noise and interference power measurement may be accomplished based on resources configured by higher layers. Otherwise, the noise and interference power may be measured based on the resources that carry the respective CSI-RS.

Received signal strength indicator (RSSI) may be measured based on the average of the total power contribution in configured OFDM symbols and bandwidth. The power contribution may be received from different resources (e.g., co-channel serving and non-serving cells, adjacent channel interference, thermal noise, and so forth)

Cross-link interference received signal strength indicator (CLI-RSSI) may be measured based on the average of the total power contribution in configured OFDM symbols of the configured time and frequency resources. The power contribution may be received from different resources (e.g., cross-link interference, co-channel serving and non-serving cells, adjacent channel interference, thermal noise, and so forth)

Sounding reference signals RSRP (SRS-RSRP) may be measured based on the linear average over the power contribution of the resource elements (RE) that carry the respective SRS.

A property of a grant or assignment may include at least one of the following: a frequency allocation; an aspect of time allocation (e.g., such as a duration); a priority; a modulation and coding scheme; a transport block size; a number of spatial layers; a number of transport blocks; a TCI state, CRI or SRI; a number of repetitions; whether the repetition scheme is Type A or Type B; whether the grant is a configured grant type 1, type 2 or a dynamic grant; whether the assignment is a dynamic assignment or a semi-persistent scheduling (configured) assignment; a configured grant index or a semi-persistent assignment index; a periodicity of a configured grant or assignment; a channel access priority class (CAPC); or any parameter provided in a DCI, by MAC or by RRC for the scheduling the grant or assignment.

An indication by DCI may include at least one of the following: an explicit indication by a DCI field or by RNTI used to mask CRC of the PDCCH or an implicit indication by a property such as DCI format, DCI size, Coreset or search space, Aggregation Level, first resource element of the received DCI (e.g., index of first Control Channel Element), where the mapping between the property and the value may be signaled by RRC or MAC.

A signal may be interchangeably used herein with one or more of following: a Sounding reference signal (SRS), a CSI-reference signal (CSI-RS), a Demodulation reference signal (DM-RS), a Phase tracking reference signal (PT-RS), or a Synchronization signal block (SSB).

A channel may be interchangeably used herein with one or more of following: a Physical downlink control channel (PDCCH); a Physical downlink shared channel (PDSCH); a Physical uplink control channel (PUCCH); a Physical uplink shared channel (PUSCH); a Physical random access channel (PRACH), etc.

Downlink reception may be used interchangeably herein with Rx occasion, PDCCH, PDSCH, or SSB reception.

Uplink transmission may be used interchangeably herein with Tx occasion, PUCCH, PUSCH, PRACH, or SRS transmission.

RS may be interchangeably used herein with one or more of RS resource, RS resource set, RS port, or RS port group.

RS may be interchangeably used herein with one or more of SSB, CSI-RS, SRS, or DM-RS.

Time instance may be interchangeably used herein with slot, symbol, or subframe.

UTCI may be interchangeably used herein with TCI, UTCI state, or TCI state.

UL-only and DL-only Tx/Rx occasions may interchangeably be used herein with legacy TDD UL or legacy TDD DL, respectively. In an example, the legacy TDD UL/DL Tx/Rx occasions may be the cases where SBFD is not configured and/or where SBFD is disabled.

The terms received signal power, received signal energy, received signal strength, SSB EPRE, CSI EPRE, RSRP, RSSI, SINR, RSRQ, SS-RSRP, SS-RSSI, SS-SINR, SS-RSRQ, CSI-RSRP, CSI-RSSI, CSI-SINR, and CSI-RSRQ may be used interchangeably herein.

An UL signal (e.g., at least one of SRS, DMRS, PUSCH, PUCCH, PRACH, PTRS, etc.) may be used interchangeably herein with a UL signal or channel, or a UL channel or signal.

A DL signal (e.g., at least one of CSI-RS, SSB, PDSCH, PDCCH, PBCH, PTRS, etc.) may be used interchangeably herein with a DL signal or channel, or a DL channel or signal.

Subband non-overlapping full duplex (SBFD) operations may be provided. A WTRU may be configured with one or more types of slots within a bandwidth, wherein a first type of slot may be used or determined for a first direction (e.g., downlink, or sidelink (e.g., WTRU-to-WTRU communication, device-to-device communication)); a second type of slot may be used or determined for a second direction (e.g., uplink, or sidelink); a third type of slot may have a first group of frequency resources within the bandwidth for a first direction and a second group of frequency resources within the bandwidth for a second direction.

The bandwidth may be interchangeably used herein with bandwidth part (BWP), carrier, subband, and system bandwidth. The first type of slot (e.g., the slot for a first direction) may be referred to herein as a downlink (and/or sidelink) slot. The second type of slot (e.g., slot for a second direction) may be referred to herein as an uplink (and/or sidelink) slot. The third type of slot may be referred to herein as a Sub-Band (non-overlapping or overlapping) Full Duplex (SBFD) slot, e.g., comprising at least one of DL SB(s), UL SB(s), sidelink SB(s), guard band(s) (or RB(s)), and flexible SB(s) (e.g., SB(s) that may be dynamically determined as one of DL SB(s), UL SB(s), sidelink SB(s)). The group of frequency resources for a first direction may be referred to herein as a downlink (and/or sidelink) subband, a downlink (and/or sidelink) frequency resource, and/or downlink (and/or sidelink) RBs. The group of frequency resources for a second direction may be referred to herein as an uplink (and/or sidelink) subband, an uplink (and/or sidelink) frequency resource, or uplink (and/or sidelink) RBs. The group of frequency resources for a flexible direction (e.g., that may be configured for a first direction, second direction, etc.) may be referred to herein as a flexible subband, a flexible frequency resource, or flexible RBs. The group of frequency resources between a first direction and a second direction may be referred to herein as a guard band, a guard frequency resource, or guard RBs.

In an example, a (SBFD-enabled) WTRU may receive configuration information or be configured with one or more SBFD UL, DL, sidelink, flexible, and/or guard subbands in one or more DL/UL/flexible TDD time instances (e.g., symbols, slots, frames, and so forth). The WTRU may be configured with one or more resource allocations for SBFD subbands.

For example, the SBFD configuration may include a flag signal (e.g., enabled/disabled), where for example a first value (e.g., zero (0)) indicates a first mode of operation (e.g., SBFD configuration), and a second value (e.g., one (1)) may indicate a second mode of operation (e.g., non-SBFD operation). The modes of operation (e.g., SBFD and/or non-SBFD) may be indicated via MIB, SIB, RRC, MAC-CE, DCI, and so forth.

The WTRU may receive the time resources (e.g., one or more symbols, slots, and so forth), for which the first mode of operation (e.g., SBFD) is defined in for example one or more BWPs, subbands, component carriers (CC), cells, and so forth. The WTRU may receive the frequency resources (e.g., subbands/BWPs including one or more PRBs) within (active and/or linked) BWP, for which the first mode of operation (e.g., SBFD) is configured. The time resources (e.g., slots, symbols) may be indicated based on periodic, semi-persistent, or aperiodic type configurations. In an example, the time resources may be indicated via a bitmap configuration, where each bit corresponds to a time resource/instance (e.g., slot, symbol, subframe, etc.) and each bit indication indicates whether a corresponding time instance may be used for the first or second mode of operation.

In an example, a WTRU may be configured with a DL TDD configuration for a component carrier (CC) or a BWP for one or more Rx occasions (e.g., via tdd-UL-DL-config-common, dedicated configurations, slot format indicator (SFI), and so forth). As such, if the first mode of operation (e.g., SBFD) is configured, one or more of the configured frequency resources (e.g., subbands, PRBs, and/or BWPs) may be configured for the transmission in UL channels and/or Tx occasions.

In another example, the WTRU may be configured with an UL TDD configuration for a component carrier (CC) or a BWP for one or more Tx occasions (e.g., via tdd-UL-DL-config-common, dedicated configurations, slot format indicator (SFI), and so forth). As such, if the first mode of operation (e.g., SBFD) is configured, one or more of the configured frequency resources (e.g., subbands, PRBs, and/or BWPs) may be configured as the DL channels and/or Rx occasions.

In another example, the WTRU may be configured with a DL, UL, or Flexible TDD configuration for a component carrier (CC) or a BWP for one or more Rx/Tx occasions (e.g., via tdd-UL-DL-config-common, dedicated configurations, slot format indicator (SFI), and so forth). As such, if the first mode of operation (e.g., SBFD) is configured, one or more of the configured frequency resources (e.g., subbands, PRBs, and/or BWPs) may be configured for the first mode of operation (e.g., either UL transmission or DL reception based on the configurations).

The duplexing mode for the first mode of operation (e.g., SBFD configuration (UL/DL)) may be indicated via a flag indication, where for example a first value (e.g., zero (0)) may indicate a first direction (e.g., UL duplexing mode), and a second the value (e.g., one (1)) may indicate a second direction (e.g., DL duplexing model).

The duplexing mode configuration and/or flag for the first mode of operation (e.g., SBFD) may be configured as part of modes of operation configuration, for example via MIB, SIB, RRC, DCI, MAC-CE, etc.

The duplexing mode configuration and/or flag for the first mode of operation (e.g., SBFD) may be configured as part of resource allocation configuration for a Tx/Rx occasion.

In an example, a WTRU may be configured with one or more types of slots. The WTRU may be configured with a first slot with a first type, where the first type may be for example SBFD slot. The WTRU may be configured with a second slot with a second type, where the second type may be for example non-SBFD slot. As for the first slot with the first type (SBFD), the WTRU may be configured with one or more DL, UL, flexible, guard, etc. subbands in the frequency domain, throughout the BWP, for the duration of the first slot. However, in the second slot with the second type (non-SBFD), the WTRU may be configured with one (e.g., only one) direction type, for example DL, UL, flexible, etc., in the frequency domain, throughout the BWP, for the duration of the second slot.

In an example, if the WTRU is configured with a second slot with UL direction, this implies legacy TDD UL slot, UL-only slot, and/or non-SBFD UL slot. In another example, if the WTRU is configured with a third slot with second type (non-SBFD) with DL direction, this implies legacy TDD DL slot, DL-only slot, and/or non-SBFD DL slot. In another example, if the WTRU is configured with a fourth slot with second type (non-SBFD) with flexible direction, this implies legacy TDD flexible slot and/or non-SBFD flexible slot, and so forth.

A WTRU may receive configurations (e.g., configuration information) of (e.g., may be configured with) SBFD subband time locations that may be configured within a period. In an example, the period may be the same as TDD-UL-DL pattern period configured by dl-UL-TransmissionPeriodicity, e.g., in TDD-UL-DL-ConfigCommon. In an (e.g., another) example, the period may be an integer multiple of TDD-UL-DL pattern period configured by dl-UL-TransmissionPeriodicity, e.g., in TDD-UL-DL-ConfigCommon.

When a (e.g., one, only one) TDD-UL-DL pattern is configured, SBFD symbols may be configured in consecutive manner within a TDD-UL-DL pattern period. When two TDD-UL-DL patterns are configured and if SBFD symbols are configured for one (e.g., only one) of the patterns, SBFD symbols may be configured in consecutive manner within the TDD-UL-DL pattern period. When two TDD-UL-DL patterns are configured and if SBFD symbols are configured for both patterns, SBFD symbols may be configured in consecutive manner within each TDD-UL-DL pattern period.

A WTRU may determine (or be indicated/configured with) that ‘UL usable PRBs’are a part of UL subband frequency resources within an UL BWP (e.g., an active UL BWP, a currently active UL BWP), and ‘DL usable PRBs’are a part of DL subband frequency resources within an DL BWP (e.g., an active DL BWP, a currently active DL BWP). The UL usable PRBs may be determined as an intersection between a configured or indicated UL subband and an active UL BWP in SBFD symbols (and/or slots). The DL usable PRBs may be determined as an intersection between a configured or indicated DL subband(s) and an active DL BWP in SBFD symbols (and/or slots). In an (e.g., another) example, the UL and/or DL usable PRBs may be explicitly configured within active UL and/or DL BWP, e.g., in SBFD symbols and/or slots.

In an example, a WTRU may receive information on frequency resource allocation (e.g., Type 0 as RBG-level bitmap-based resource assignment) for a PDSCH or PUSCH (as being scheduled) in a slot(s). When an assigned RBG overlaps with a subband boundary, the WTRU may determine that PRBs (e.g., only the PRBs) within DL usable PRBs are to be valid for PDSCH reception and PRBs (e.g., only the PRBs) within UL usable PRBs are to be valid for PUSCH transmission, e.g., where this may imply “partial RBG” is allowed and valid for resource allocation.

Separate QCL or TCI-state may be used for SBFD symbol type and non-SBFD symbol type. In an SBFD system, across SBFD symbols and non-SBFD symbols, it needs to be determined whether separate quasi co-location(QCL) and/or TCI-state configurations are applied or not, in consideration of different interference nature on different symbol types, e.g., due to non-negligible self-interference when using a DL beam on SBFD symbols.

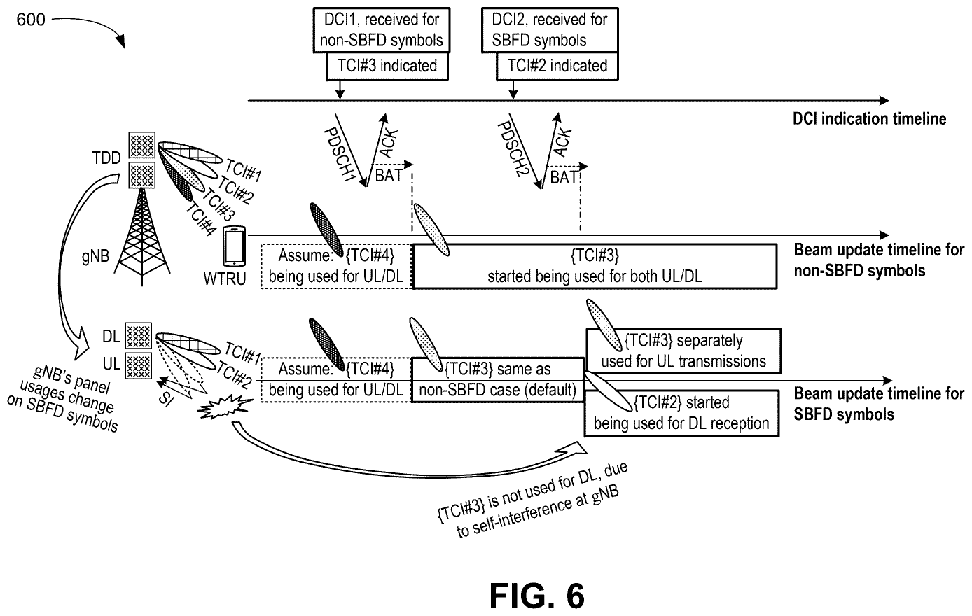

FIG. 6 depicts an example TCI or beam control 600 across FD and non-FD symbols. For example, the TCI or beam control 600 is an example of how to achieve separated beam/TCI control across different SBFD symbol type in a single TRP scenario and under unified TCI (UTCI) framework. A WTRU may receive configuration of a plurality of TCI-states. The WTRU may receive a TCI-activation command (e.g., via a MAC-CE) indicating (e.g., activating, updating, etc.) an activated set of TCI-states (e.g., TCI #1, TCI #2, TCI #3, TCI #4 in FIG. 6 as examples) among the plurality of TCI-states. In an example, the WTRU may maintain (e.g., track, keep tracking) one or more quasi co-location (QCL) properties based on RSs within the activated set of TCI-states, where the one or more QCL properties may comprise at least one of {average delay, Doppler shift, delay spread, Doppler spread, spatial Rx, and/or average power}, e.g., upon receiving the TCI-activation command. In an example, the WTRU may not maintain (e.g., track) the QCL properties for an RS of a TCI-state (among the plurality of TCI-states) that is not activated by the TCI-activation command. The activated set of TCI-states may be ready for being used for a transmission or a reception when scheduled.

The WTRU may receive a first DCI (DCI1) scheduling a first PDSCH (PDSCH1) (or without scheduling a PDSCH) and indicating a first TCI-state (e.g., TCI #3) among the activated set of TCI-states. The WTRU may receive (e.g., decode, demodulate) the first PDSCH using TCI #X (e.g., X=4) that is a previously indicated TCI-state which may not be the same as the indicated TCI #3. In response to receiving the first PDSCH (using TCI #4), the WTRU may transmit an ACK (to a gNB) indicating a successful reception of the first PDSCH and/or a successful reception of the indicated first TCI-state (TCI #3). The WTRU may (be configured to) start to apply the indicated first TCI-state (TCI #3) T_BAT after transmitting the ACK, where a value of a beam application time (BAT), e.g., the T_BAT, may be configured by the gNB. Until further receiving a second indicated TCI-state (e.g., by DCI2), the WTRU may maintain (e.g., in terms of the QCL properties) the indicated first TCI-state (TCI #3) for use of communications (for UL transmissions and/or DL receptions) with the gNB.

The WTRU may determine that the reception of DCI1 or the first TCI state (TCI #3) is associated with non-SBFD symbols, e.g., in terms of TCI/beam update. The determination may be based on an explicit indication from a gNB and/or based on an implicit rule, e.g., on condition of the symbol(s) where the DCI1 is received, which CORESET (and/or search space) the DCI1 is received, which RNTI the detected DCI1 is scrambled with, and so forth. Based on determining that the reception of DCI1 or the first TCI state (TCI #3) is associated with non-SBFD symbols, the WTRU may update the indicated first TCI state (TCI #3) for UL transmissions and/or DL receptions, e.g., at least for non-SBFD symbols, or for both non-SBFD symbols and SBFD symbols until a SBFD-specific TCI control command is received. In an example (e.g., by default), until (e.g., unless) a SBFD-specific TCI control command is received, the WTRU may use the first TCI state (TCI #3) also in association with SBFD symbols, e.g., for UL transmissions and/or DL receptions. In an example, the WTRU may transmit a first UL channel or signal (e.g., PUSCH, PUCCH, SRS) using the first TCI state (TCI #3), and/or receive a first DL channel or signal (e.g., PDSCH, PDCCH, CSI-RS) using the first TCI state (TCI #3).

The WTRU may receive a second DCI (DCI2) scheduling a second PDSCH (PDSCH2) (or without scheduling a PDSCH) and indicating a second TCI-state (e.g., TCI #2) among the activated set of TCI-states. The WTRU may receive (e.g., decode, demodulate) the second PDSCH using a previously indicated TCI-state (which is TCI #3 indicated by the DCI1). In response to receiving the second PDSCH (using TCI #3), the WTRU may transmit an ACK (to a gNB) indicating a successful reception of the second PDSCH and/or a successful reception of the indicated second TCI-state (TCI #2). The WTRU may (be configured to) start to apply the indicated second TCI-state (TCI #2) for at least one communication direction (e.g., DL), T_BAT2 after transmitting the ACK, where a BAT of T_BAT2 may be configured by the gNB and may be same as or independent from the T_BAT.

The WTRU may determine that the reception of DCI2 or the second TCI state (TCI #2) is associated with SBFD symbols, e.g., in terms of TCI/beam update, where the reception of the DCI2 may correspond to the SBFD-specific TCI control command. The determination may be based on an explicit indication from a gNB and/or based on an implicit rule, e.g., on condition of the symbol(s) where the DCI2 is received, which CORESET (and/or search space) the DCI2 is received on, which RNTI the detected DCI2 is scrambled with, and so forth. Based on determining that the reception of DCI2 or the second TCI state (TCI #2) is associated with SBFD symbols, the WTRU may update the indicated second TCI state (TCI #2) for one communication direction (e.g., either UL transmission, or DL reception), where the one communication direction the WTRU applies for may be (pre-)configured or (separately) indicated by the gNB. In an example, based on determining that the reception of DCI2 or the second TCI state (TCI #2) is associated with SBFD symbols, the WTRU may update the indicated second TCI state (TCI #2) for DL receptions (e.g., on condition that the one communication direction is configured or indicated as a DL direction), e.g., while the WTRU may continue to use the first TCI state (TCI #3) in association with SBFD symbols for UL transmissions. In an example, the WTRU may continue to use the first TCI state (TCI #3) in association with non-SBFD symbols, e.g., for UL transmissions and/or DL receptions.

In an (e.g., another) example, based on determining that the reception of DCI2 or the second TCI state (TCI #2) is associated with SBFD symbols, the WTRU may update the indicated second TCI state (TCI #2) for (e.g., both) UL transmissions and/or DL receptions which the WTRU performs on SBFD symbol(s), while the WTRU may continue to use the first TCI state (TCI #3) in association with non-SBFD symbols, e.g., for UL transmissions and/or DL receptions.

Based on receiving the SBFD-specific TCI control command (e.g., the DCI2), the WTRU may transmit a second UL channel or signal using the first TCI state (TCI #3) on SBFD symbol(s) and/or non-SBFD symbol(s). The WTRU may receive a second DL channel or signal using the second TCI state (TCI #2) on SBFD symbol(s), while the WTRU may receive a third DL channel or signal by using the first TCI state (TCI #3) on non-SBFD symbol(s). This may provide benefits in terms of improving reliability in one communication direction performance (e.g., UL performance) while maintaining an optimized performance for another (e.g., the other) communication direction, e.g., when the gNB transmits a DL signal from a first gNB panel and simultaneously receives a UL signal at a second gNB panel, and some of DL beams (TCIs) (e.g., TCI #3, TCI #4) cause a self-interference (SI) on the UL reception, e.g., due to signal reflection, diffraction, by a clutter, obstacle, or by a non-ideal spatial-separation between the first and second gNB panels, etc.

A WTRU may receive (e.g., from a gNB, a node, or a device) configurations for (e.g., configuration information associated with) full-duplex (FD) operation conducted by at least one device in a network. In an example, the FD operation may be conducted by a gNB (e.g., a BS, a node, a TRP, a cell). The WTRU may operate in a half-duplex (HD) mode for communicating with the gNB, where the HD mode may imply at a given time the WTRU either performs a UL transmission or a DL reception (not both simultaneously at the given time). The WTRU may (also) operate in an FD mode for communicating with the gNB, e.g., if a corresponding WTRU capability signal(s) is reported to the gNB and/or the WTRU receives a confirmation signal (e.g., enabling the FD, configuring the FD mode) in response to transmitting the WTRU capability signal(s).

The FD operation may imply at a given time a transmitter (e.g., the gNB and/or the WTRU) may simultaneously transmit a first signal and receive a second signal. The FD operation may comprise a subband overlapping FD (e.g., in-band FD (IBFD), spectrum-shared full duplex (SSFD)) operation where a first frequency-domain resource (e.g., RBG(s), RB(s), RE(s)) allocated for the first signal may have a full (or at least a partial) overlap with a second frequency-domain resource allocated for the second signal. The FD operation may comprise a subband non-overlapping FD (SBFD) operation where a first frequency-domain resource allocated for the first signal (e.g., assigned within a configured SBFD subband, e.g., DL subband, usable DL PRBs) does not have an overlap with a second frequency-domain resource allocated for the second signal (e.g., assigned within a configured SBFD subband, e.g., UL subband, usable UL PRBs).

The FD operation as used herein may comprise the SBFD operation, however the solutions and examples in the disclosure may equally (or equivalently or extendedly, etc.) be employed (e.g., applicable) for cases with other FD operation types (e.g., IBFD, etc.).

A WTRU may receive SBFD-related configuration(s), e.g., for frequency-domain location information of one or more subbands (e.g., DL subband, UL subband, flexible DL/UL subband, and/or guardband), and/or for time-domain location information of the one or more subbands. The time-domain location information may indicate a set of non-SBFD symbols and a set of SBFD symbols (e.g., as illustrated in FIG. 1). A symbol(s) within the set of non-SBFD symbols may be a type of ‘DL symbol’, ‘UL symbol’ or ‘flexible symbol’. The WTRU may receive a DL signal on symbol(s) based on a type of ‘DL symbol’ in the set of non-SBFD symbols. The WTRU may transmit a UL signal on symbol(s) based on a type of ‘UL symbol’ in the set of non-SBFD symbols. The WTRU may either receive a DL signal or transmit a UL signal on symbol(s) based on a type of ‘flexible symbol’ in the set of non-SBFD symbols, e.g., depending on one or more conditions with other signal(s) co-existing in the symbol(s).

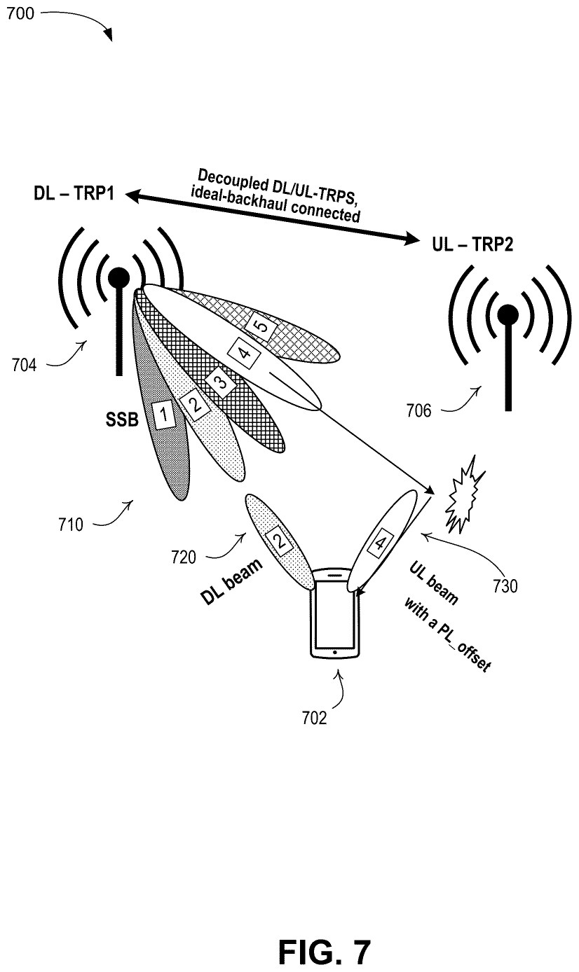

FIG. 7 depicts example associations 700 between a first SSB 720 and one or more second SSBs (e.g., such as second SSB 730). A WTRU 702 may use pre-associations between the first SSB 720 (e.g., from DL-TRP1 704) and one or more second SSBs 730 (e.g., for UL-TRP2 706) with corresponding ROs.

The WTRU 702 may detect a first SSB 720 (e.g., SSB #2). For example, the WTRU 702 may receive the first SSB 720 from a first TRP 704. The WTRU 702 may determine a first spatial-domain filter being used for reception of the first SSB 720.

The WTRU 702 may receive configuration information (e.g., via system information based on the detected SSB 720) associated with the first TRP 704. The configuration information may include (e.g., indicate) one or more of the following. The configuration information may include a plurality of synchronization signal block (SSB) indexes, e.g., via system information, of a cell. The configuration information may include a plurality of pathloss(PL)-offset parameters (e.g., values in dB), e.g., PL-offset #1, 2, 3, 4, 5, 6, etc. The configuration information may include pre-associations between a plurality of first SSBs 710 associated with the first TRP 704 and a plurality of second SSBs (e.g., such as second SSB 730) associated with a random access procedure. For example, the pre-associations (e.g., signaled by SIB) may be between SSBs (of the plurality of SSBs) to be applied for a random access procedure, e.g., determining one or more ROs to transmit a PRACH upon detecting an SSB. The pre-associations may include a first SSB index 720, e.g., SSB #2 (transmitted from DL-TRP1) and one or more second SSB indexes 730. For example, SSB #4 (representing a geographically-separated UL-TRP2), where each of the one or more second SSB indexes 730 may be mapped to a separate RO. The pre-associations may include a third SSB index, e.g., SSB #1 (transmitted from DL-TRP1) and one or more fourth SSB indexes, e.g., SSB #2, 3, 11, 12 (for UL-TRP2), where each of the one or more fourth SSB indexes may be mapped to a separate RO.

The configuration information may include mapping information between an SSB and a PL-offset. Each of the one or more second (or fourth) SSB indexes may be associated with (e.g., linked to, mapped to) a corresponding PL offset which is used for determining a PRACH power (e.g., in consideration of a proper Tx power level determination for the geographically-separated UL-TRP2). For example, each of the one or more second (or fourth) SSBs may further have its association to a PL-offset, e.g., SSB #4 may be associated with PL-offset #1, SSB #2 may be associated with PL-offset #5, SSB #3 may be associated with PL-offset #6, SSB #11, 12 may be (commonly) associated with PL-offset #9.

The configuration information may include mapping information between the plurality of second SSBs and respective ROs. For example, the configuration information may include information related to an SSB-to-RO mapping rule, e.g., SSB #1 maps to RO #1, SSB #2 maps to RO #2, etc. Each RO may represent a time and frequency location of the RO over which the WTRU may transmit a PRACH. The resulting number of ROs (e.g., 96) may be larger than the number of SSBs (e.g., 64). The configuration information may include first time and frequency location information on one or more downlink subbands in one or more SBFD slots or time and frequency location information associated with one or more uplink subbands in the one or more SBFD slots.

The WTRU 702 may determine to use one or more of the plurality of second SSBs for a random access procedure based on the pre-associations. For example, the WTRU 702 may determine, based on the pre-associations, the one or more second SSB indexes 730 (e.g., SSB #4) being associated with the detected first SSB index 720. The WTRU 702 may determine a second spatial-domain (e.g., Rx and/or Tx) filter associated with (e.g., being used for receiving) the SSB #4 and a Tx power level based on the PL-offset #1 associated with SSB #4. For example, the WTRU 702 may determine a transmit power level for the random access message based on a PL offset associated with the second SSB 730. The WTRU 702 may determine a corresponding RO index (e.g., RO #4) mapped to the second SSB 730 (e.g., the determined SSB #4).

The WTRU 702 may send a random access message (e.g., PRACH message) to a second TRP 706 using the second SSB 730 (e.g., the determined SSB #4). For example, the WTRU 702, in response to detecting the SSB #2 720, may send a PRACH (e.g., Msg1, toward the UL-TRP2) by using the determined Tx power level and/or the second spatial-domain filter (e.g., determined based on SSB #4) and on the determined RO (RO #4). The WTRU 702 may perform a beam sweep (e.g., around the first SSB 720 or the second SSB 730) to determine which of a plurality of second SSBs to use to send an uplink transmission (e.g., a PUSCH transmission). For example, the WTRU 702 may send the random access message using a plurality of second SSBs on a plurality of uplink beams with respective directions that are proximate to a direction of the downlink beam associated with the first SSB 720.

The WTRU 702 may receive a random-access response (RAR) (e.g., Msg2) transmitted from the first TRP 704 (e.g., the DL-TRP1), for example, using the first spatial-domain filter. The RAR may comprise a scheduling grant for a PUSCH transmission, e.g., to be transmitted by using the second spatial-domain filter. The RAR message may indicate a selection of one of the plurality of uplink beams to use for the PUSCH transmission.

SSB detection may be provided in a network based on decoupled TRPs. A WTRU may detect, e.g., during an initial access (random access), a first SSB (e.g., SSB #2 in FIG. 7) where the first SSB may be transmitted from a first TRP (e.g., TRP1, cell1, BS1, etc.). The first TRP may transmit DL channels or signals but may not receive any (e.g., all, some, a set of) UL channels or signals, where the first TRP may be associated with a second TRP (e.g., TRP2, cell2, BS2, etc.) that is for receiving UL channels or signals. The association between the first TRP and the second TRP may be based on at least one of following components which may be separated (e.g., decoupled) between the TRPs, e.g., providing benefits in terms of network energy saving, interference reduction, reducing self-interference e.g. in a network operating a duplex scheme such as SBFD, and so on.

The association between the first TRP and the second TRP may be based on at least one communication direction, e.g., at least one among {DL, UL, sidelink(SL) for WTRU-to-WTRU communications, etc.}, e.g., in a form of strictly decoupled DL and UL TRPs. TRP1 may be dedicated for DL transmissions and TRP2 may be dedicated for UL receptions, e.g., in a form of strictly decoupled DL and UL TRPs. TRP1 may be a main TRP (for both DL transmissions and UL receptions) and TRP2 may be dedicated for UL receptions, which may form a deployment scenario of asymmetric TRPs (asymmetric DL/UL TRPs). TRP1 may be dedicated for DL transmissions and TRP2 may be for both UL receptions and receptions of SL channels or signals. TRP1 may be for DL transmissions and transmissions of SL control signals and TRP2 may be for UL receptions and receptions of SL channels or signals (e.g., SL control signals from UE(s)).

The association between the first TRP and the second TRP may be based on at least one spatial-domain control, parameter(s). For example, communications with TRP1 (e.g., transmitting DL channels or signals) may be based on a first spatial-domain parameter (e.g., a first QCLed RS, a first QCL information component, a first TCI-state, a first RS of a first TCI-state, etc.), and/or communications with TRP2 (e.g., receiving UL channels or signals) may be based on a second spatial-domain parameter.

The association between the first TRP and the second TRP may be based on at least one frequency-domain resource allocation component, parameter(s). For example, communications with TRP1 (e.g., transmitting DL channels or signals) may be based on a first frequency-domain parameter, e.g., a first group of PRBs, a first cell, a first BWP, a first bandwidth, a first component carrier, a first DL subband (e.g., when a type of duplex operations is enabled such as SBFD, IBFD, SSFD), and communications with TRP2 (e.g., receiving UL channels or signals) may be based on a second frequency-domain parameter.

The association between the first TRP and the second TRP may be based on at least one time-domain resource allocation component, parameter(s). For example, communications with TRP1 (e.g., transmitting DL channels or signals) may be based on a first time-domain parameter, e.g., a first group of time units such as frames, subframes, slots, symbols, etc. (e.g., for (separate) interference management, for energy saving operations), a first symbol (or other time unit) type (e.g., SBFD symbol type, FD symbols, when a type of duplex operations is enabled such as SBFD, IBFD, SSFD), and/or communications with TRP2 (e.g., receiving UL channels or signals) may be based on a second time-domain parameter.

The association between the first TRP and the second TRP may be based on at least one power-domain control, parameter(s). For example, communications with TRP1 (e.g., transmitting DL channels or signals) may be based on a first power-domain parameter which may be for the WTRU to receive at least a part of the DL channels or signals (that may be applied by a DL transmission power adjustment, e.g., for interference management, for energy saving operations, and/or for duplex operation based on CLI mitigation, etc.), and communications with TRP2 (e.g., receiving UL channels or signals) may be based on a second spatial-domain parameter, e.g., a pathloss(PL) offset parameter(s), a UL power control related parameter, etc. For example, the WTRU may determine a UL transmission power level based on the PL offset parameter applied on a PL estimation performed on measuring a DL RS transmitted from the TRP1 (e.g., based also on the first power-domain parameter).

A WTRU may receive configurations (e.g., configuration information) based on the detected SSB. The WTRU may determine a first spatial-domain filter (e.g., spatial Rx (beam), spatial Tx (beam), spatial Rx and Tx beam based on beam correspondence or reciprocity property, spatial QCL reference, beam direction filter coefficients, etc.) being used for reception of the first SSB. The WTRU may, e.g., based on the first spatial-domain filter, receive configuration information, e.g., via system information (broadcasted) based on (e.g., associated with) the detected SSB (such as using the first spatial-domain filter), comprising at least one of the following.

The configuration information may include a plurality of synchronization signal block (SSB) indexes, e.g., via the system information, of a cell, a TRP (e.g., the TRP1), a BS, etc.

The configuration information may include a plurality of pathloss(PL)-offset parameters (values, e.g., in dB), e.g., PL-offset #1, 2, 3, 4, 5, 6, . . .

The configuration information may include information on pre-associations (e.g., signaled by SIB) between SSBs (of the plurality of SSBs) to be applied for a random access procedure, e.g., determining one or more RACH occasions (ROs) to transmit a PRACH upon detecting an SSB (e.g., the SSB #2 in FIG. 6). The pre-associations may include a first SSB index, e.g., SSB #2 (transmitted from DL-TRP1) and one or more second SSB indexes, e.g., SSB #4 (representing a geographically-separated UL-TRP2), where each of the one or more second SSB indexes may be mapped to a separate RO. The pre-associations may include a third SSB index, e.g., SSB #1 (transmitted from DL-TRP1) and one or more fourth SSB indexes, e.g., SSB #2, 3, 11, 12 (for UL-TRP 2), where each of the one or more fourth SSB indexes may be mapped to a separate RO.

A default association (e.g., for SSB(s) that is not configured with (e.g., not a part of) the pre-associations) may be defined or configured such that the same SSB index is used for a PRACH transmission and/or RO determination. In an example, a default association may include SSB #3 (transmitted from DL-TRP1) and SSB #3 (for UL-TRP2, e.g., where (almost) same Rx/Tx beam determined based on SSB #3 may be used for a PRACH transmission toward UL-TRP2). The default association may include SSB #4 (transmitted from DL-TRP1) and SSB #4 (for UL-TRP2, e.g., where (almost) same Rx/Tx beam determined based on SSB #4 may be used for a PRACH transmission toward UL-TRP2). The default association may include SSB #X (e.g., for any SSB #X that is not configured with (e.g., not a part of) the aforementioned pre-associations).

The configuration information may include mapping information between an SSB and a PL-offset. Each of the one or more second (or fourth) SSB indexes may be associated with (e.g., linked to, mapped to) a corresponding PL offset. The PL offset may be used for determining a PRACH power (e.g., in consideration of a proper Tx power level determination for the geographically-separated UL-TRP2). For example, each of the one or more of the second (or fourth) SSBs may further have its association to a PL-offset, e.g., SSB #4 is associated with PL-offset #1; SSB #2 is associated with PL-offset #5; SSB #3 is associated with PL-offset #6; SSB #11, 12 is (commonly) associated with PL-offset #9; etc.

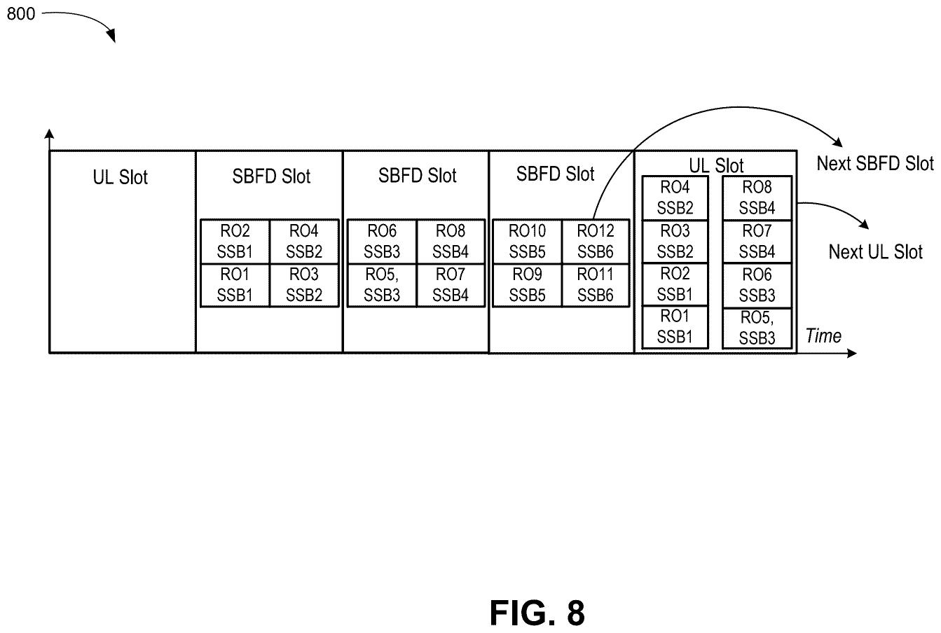

The configuration information may include information related to a SSB-to-RO mapping rule, e.g., SSB #1 maps to RO #1, SSB #2 maps to RO #2, etc. FIG. 8 depicts an example SSB-RO mapping 800 with ascending order of SSB indexes in ROs. Each RO (e.g., being not overlapped with any other ROs, or being allowed to overlap with second RO(s) and applying a configured priority rule to determine which RO to use when such overlap occurs) represents a time and frequency location of the RO over which the WTRU may transmit a PRACH. In an example, a first SSB-to-RO mapping rule (e.g., in UL slot or in SBFD slots) may be based on ascending order of SSB indexes 1-to-M (M=1,2, . . . configurable) mapped to (valid) ROs, e.g., by mapping frequency-domain first and time-domain second, illustrated in FIG. 7 with an example of a configured FDM parameter M=2. This may result in the following SSB-to-RO mapping (based on examples of FIG. 8 with M=2): SSB #1 maps to RO #1 and RO #2; SSB #2 maps to RO #3 and RO #4; SSB #3 maps to RO #5 and RO #6 . . . SSB #K (e.g., K=16 in the cell1, TRP1, BS 1) maps to RO #{2K−1} and RO #{2K}. In this example, a total 2K ROs (e.g., 32 ROs due to K=16) may be mapped in a full cycle of SSB-to-RO mapping and the WTRU may transmit a PRACH out of the 2K different PRACH transmission occasions.

In an example, based on the information on pre-associations such as SSB #1 being pre-associated with SSB #2, 3, 11, 12 (e.g., for UL-TRP 2) each being mapped to a separate RO, the WTRU may determine a second SSB-to-RO mapping rule (e.g., even though the same M=2 and K=16 are given) resulting in the following SSB-to-RO mapping: SSB #1 maps to RO #1&2 (e.g., pre-associated with SSB #2), RO #3&4 (e.g., pre-associated with SSB #3), RO #5&6 (pre-associated with SSB #11), and RO #7&8 (e.g., pre-associated with SSB #12); SSB #2 maps to RO #9&10 (e.g., pre-associated with SSB #4); SSB #3 maps to at least RO #11&12 (e.g., pre-associated with at least SSB #X, where X may be 3, e.g., based on the default association); and SSB #4 maps to at least RO #13&14 (e.g., pre-associated with at least SSB #Y, where Y may be 4, e.g., based on the default association).

Where in this example, more than 2K ROs (e.g., more than 32 ROs due to K=16 and at least the case of SSB #1 mapped to 8 ROs based on the pre-associated SSB #2, 3, 11, 12 to have separate PRACH transmission occasions for each of pre-associated SSBs) may be mapped in a full cycle of SSB-to-RO mapping, and the WTRU may transmit one or more PRACHs out of more than 2K different PRACH transmission occasions. In an example, on condition that the WTRU detects the SSB #1 from DL-TRP1, the WTRU may (be configured to) transmit more than one PRACH (e.g., all or a subset of 8 PRACHs, e.g., based on one or more configured conditions or rules) out of the 8 ROs based on the pre-associated SSB #2, 3, 11, 12.

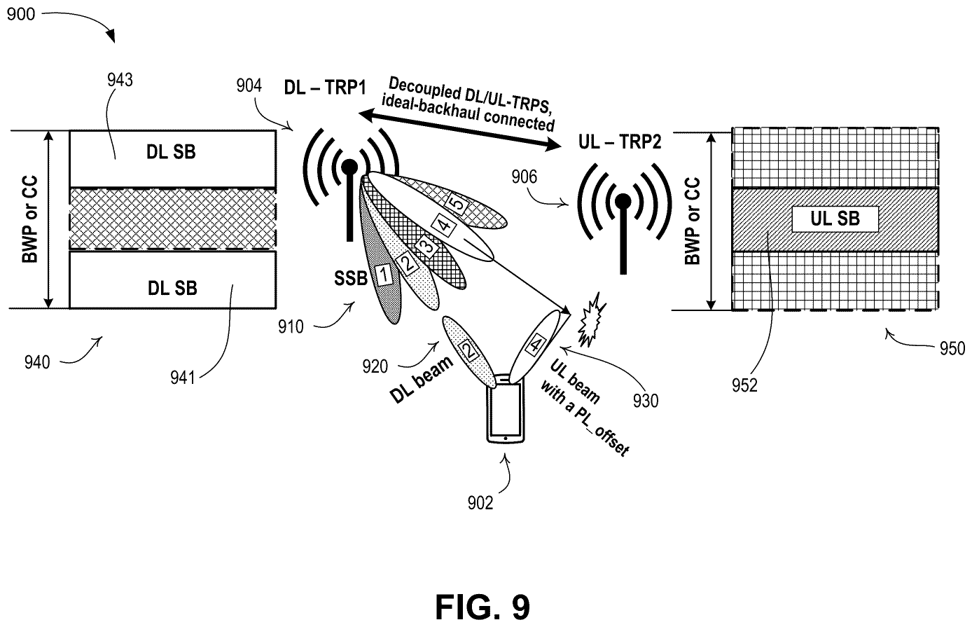

FIG. 9 is a diagram illustrating example associations 900 between a first SSB 920 and one or more second SSBs (e.g., such as second SSB 930) in an SBFD system. A WTRU 902 may detect a first SSB 920 (e.g., SSB #2). For example, the WTRU 902 may receive the first SSB 920 from a first TRP 904. The first TRP 904 may transmit on a plurality of first SSBs 910. The plurality of SSBs 910 may include the first SSB 920 (e.g., SSB #2). The WTRU 902 may determine a first spatial-domain filter being used for reception of the first SSB 920.

The WTRU 902 may receive configuration information (e.g., via system information based on the detected SSB 920) associated with the first TRP 904. The configuration information may include (e.g., indicate) one or more of the following. The configuration information may include a plurality of synchronization signal block (SSB) indexes, e.g., via system information, of a cell. The configuration information may include a plurality of pathloss(PL)-offset parameters (e.g., values in dB), e.g., PL-offset #1, 2, 3, 4, 5, 6, etc. The configuration information may include pre-associations between the plurality of first SSBs 910 associated with the first TRP 904 and a plurality of second SSBs (e.g., such as second SSB 930) associated with a random access procedure. For example, the pre-associations (e.g., signaled by SIB) may be between SSBs (of the plurality of SSBs) to be applied for a random access procedure, e.g., determining one or more RACH occasions (ROs) to transmit a PRACH upon detecting an SSB. The pre-associations may include a first SSB index 920, e.g., SSB #2 (transmitted from DL-TRP1) and one or more second SSB indexes 930. For example, SSB #4 (representing a geographically-separated UL-TRP2), where each of the one or more second SSB indexes 930 may be mapped to a separate RO. The pre-associations may include a third SSB index, e.g., SSB #1 (transmitted from DL-TRP1) and one or more fourth SSB indexes, e.g., SSB #2, 3, 11, 12 (for UL-TRP2), where each of the one or more fourth SSB indexes may be mapped to a separate RO.

The configuration information may include mapping information between an SSB (e.g., the second SSB 930) and a PL-offset. Each of the one or more second (or fourth) SSB indexes may be associated with (e.g., linked to, mapped to) a corresponding PL offset which is used for determining a PRACH power (e.g., in consideration of a proper Tx power level determination for the geographically-separated UL-TRP2). For example, each of the one or more second (or fourth) SSBs may further have its association to a PL-offset, e.g., SSB #4 may be associated with PL-offset #1, SSB #2 may be associated with PL-offset #5, SSB #3 may be associated with PL-offset #6, SSB #11, 12 may be (commonly) associated with PL-offset #9.

The configuration information may include mapping information between the plurality of second SSBs (e.g., such as the second SSB 930) and respective ROs. For example, the configuration information may include information related to an SSB-to-RO mapping rule, e.g., SSB #1 maps to RO #1, SSB #2 maps to RO #2, etc. Each RO may represent a time and frequency location of the RO over which the WTRU may transmit a PRACH. The resulting number of ROs (e.g., 96) may be larger than the number of SSBs (e.g., 64). The configuration information may include first time and frequency location information on one or more downlink subbands in one or more SBFD slots or time and frequency location information associated with one or more uplink subbands in the one or more SBFD slots.

The configuration information may include full-duplex (FD) related information 940, 950, e.g., SBFD subband time and/or frequency locations (e.g., based on examples shown in FIG. 8 and FIG. 9). FD related information may include time/frequency location information 941, 943 on one or more DL subbands (e.g., for reception, from a TRP such as DL-TRP #1 904). For example, a first DL subband 941 may span a first set of PRBs and a second DL subband may span a second set of PRBs 943. FD related information may include time/frequency location information 952 on one or more UL subbands (e.g., for transmission, to a TRP such as UL-TRP #2 906). For example, a first UL subband may span a third set of PRBs 952.

In an example, the WTRU 902 may detect the first SSB index (e.g., SSB #2, transmitted from the DL-TRP1), e.g., within a DL subband 941, 943 (e.g., spanning over either the 1st set of PRBs or the 2nd set of PRBs), configured for the DL-TRP1 904. The WTRU 902 may determine to use RO #9 and/or RO #10 (pre-associated with SSB #4, based on a configuration or indication, based on the above example) to transmit one or more PRACHs, e.g., within a UL subband 952 (e.g., spanning over the 3rd set of PRBs). Based on the determination, the WTRU 902 may transmit a first PRACH on RO #9 and a second PRACH on RO #10, e.g., within the UL subband 952 (e.g., spanning over the 3rd set of PRBs).

The WTRU 902 may determine to use one or more of the plurality of second SSBs for a random access procedure based on the pre-associations. For example, the WTRU 902 may determine, based on the pre-associations, the one or more second SSB indexes 930 (e.g., SSB #4) being associated with the detected first SSB index 920. The WTRU 902 may determine a second spatial-domain (e.g., Rx and/or Tx) filter associated with (e.g., being used for receiving) the SSB #4 and a Tx power level based on the PL-offset #1 associated with SSB #4. For example, the WTRU 902 may determine a transmit power level for the random access message based on a PL offset associated with the second SSB 930. The WTRU 902 may determine a corresponding RO index (e.g., RO #4) mapped to the second SSB 930 (e.g., the determined SSB #4).

The WTRU 902 may send a random access message (e.g., PRACH message) to a second TRP 906 using the second SSB 930 (e.g., the determined SSB #4). For example, the WTRU 902, in response to detecting the SSB #2 920, may send a PRACH (e.g., Msg1, toward the UL-TRP2) by using the determined Tx power level and/or the second spatial-domain filter (e.g., determined based on SSB #4) and on the determined RO (RO #4). The WTRU 902 may perform a beam sweep (e.g., around the first SSB 920 or the second SSB 930) to determine which of a plurality of second SSBs to use to send an uplink transmission (e.g., a PUSCH transmission). For example, the WTRU 902 may send the random access message using a plurality of second SSBs on a plurality of uplink beams with respective directions that are proximate to a direction of the downlink beam associated with the first SSB 920.

The WTRU 902 may receive (e.g., via the first SSB 920) a random-access response (RAR) (e.g., Msg2) transmitted from the first TRP 904 (e.g., the DL-TRP1), for example, using the first spatial-domain filter. The RAR may comprise a scheduling grant for a PUSCH transmission, e.g., to be transmitted by using the second spatial-domain filter. The RAR message may indicate a selection of one of the plurality of uplink beams to use for the PUSCH transmission.

A WTRU may determine one or more associated second SSB indexes for use with a set of decoupled TRPs.

The WTRU may determine, based on the pre-associations, the one or more second SSB indexes (e.g., SSB #4) being associated with the detected first SSB index (e.g., SSB #2), e.g., as illustrated in FIG. 7 and FIG. 9. The WTRU may determine a second spatial-domain filter (e.g., spatial Rx (beam), spatial Tx (beam), spatial Rx and Tx beam based on beam correspondence or reciprocity property, spatial QCL reference, beam direction filter coefficients, etc.) associated with (e.g., being used for receiving or measuring) the SSB #4. In an example, the second spatial-domain filter may be used for a UL transmission (e.g., a corresponding PRACH transmission toward the UL-TRP2 in response to detecting the first SSB index), where an actual transmission direction may point to an opposite (beam) direction based on the second spatial domain filter determined by measuring the SSB4, e.g., based on or according to the beam correspondence or reciprocity property.

A WTRU may determine a RO based on the associated second SSB index(es).

The WTRU may determine a corresponding RO index based on (e.g., mapped to) the detected SSB #2 and/or determined pre-associated SSB #4, where such SSB-to-RO mapping rule may be configured or indicated. In an example, the corresponding RO index may be RO #9 and/or RO #10 based on the aforementioned examples of SSB-to-RO mapping, as follows. SSB #1 may map to RO #1&2 (e.g., pre-associated with SSB #2), RO #3&4 (e.g., pre-associated with SSB #3), RO #5&6 (e.g., pre-associated with SSB #11), and RO #7&8 (e.g., pre-associated with SSB #12). SSB #2 may map to RO #9&10 (e.g., pre-associated with SSB #4). SSB #3 may map to at least RO #11&12 (e.g., pre-associated with at least SSB #X, where X may be 3, e.g., based on the default association). SSB #4 may map to at least RO #13&14 (e.g., pre-associated with at least SSB #Y, where Y may be 4, e.g., based on the default association).

A WTRU may send a PRACH (e.g., Msg1) transmission based on the determined RO(s).

The WTRU (e.g., in response to detecting the SSB #2) may transmit a PRACH (e.g., Msg1, toward the UL-TRP2) by using the second spatial-domain filter (e.g., determined based on SSB #4 being pre-associated with the SSB #2) and on the determined RO (e.g., RO #9 and/or RO #10). The WTRU may determine a Tx power of the PRACH based on the associated PL-offset parameter(s) (e.g., PL-offset #1 associated with the SSB #4, being pre-associated with SSB #2), and/or one or more PRACH power control related parameters such as {PCMAX (e.g., possible maximum power), PreambleReceivedTargetPower (e.g., desired received power level at the BS, e.g., in [dB]), or PowerRampingStep (e.g., used for each retransmission (re-attempt) of the PRACH transmission with a power ramping function), etc.}. In an example, the WTRU may determine the PRACH Tx power level based on the associated PL-offset (e.g., Q [dB] indicated based on the PL-offset #1) plus a determined Tx power level based on the one or more PRACH power control related parameters. The WTRU (e.g., in response to detecting the SSB #2) may transmit the PRACH on the determined RO(s) (e.g., RO #9 and/or 10) by using the determined PRACH Tx power level and/or the second spatial-domain filter.

In an example, the WTRU may (be configured to) determine whether the RO #9 and/or RO #10 is within the 1st UL subband (configured for the UL-TRP2). In an example, the WTRU may transmit the PRACH on the RO #9 and/or RO #10 on condition that the RO #9 and/or RO #10 is within the 1st UL subband (configured for the UL-TRP2), e.g., when the RO #9 is within (e.g., only within) the 1st UL subband, the WTRU may transmit the PRACH on the RO #9 and not transmit the PRACH on the RO #10.

The WTRU may receive a random-access response (RAR) (e.g., Msg2, transmitted from the DL-TRP1, e.g., on either the 1st or 2nd DL subband), for example, by using the first spatial-domain filter. The RAR may include a scheduling grant for a PUSCH transmission. In an example, the WTRU may receive a DCI and the RAR may be scheduled by the DCI. The RAR may include a RA preamble identifier (e.g., matched to the transmitted PRACH), a temporary C-RNTI (TC-RNTI), a timing advance command, a UL grant of the PUSCH (e.g., Msg3) for WTRU to transmit, and/or one or more parameters indicating which transmitted PRACH(s) and/or which RO(s) are the RAR is referring (e.g., responding, pointing) to.

A WTRU may send an initial PUSCH scheduled by the RAR. Based on the RAR, the WTRU may transmit the PUSCH (e.g., Msg3, toward the UL-TRP2) by using the second spatial-domain filter, e.g., where the WTRU may determine a valid resource for the PUSCH is within the 1st UL subband. In an example, the WTRU may transmit the PUSCH (e.g., RRC connection request, e.g., Msg3) or an associated UL transmission, scheduled by the UL grant (e.g., received via the RAR).

The WTRU may receive a RRC setup message (e.g., Msg4, transmitted from the DL-TRP1, on either the 1st or 2nd DL subband) by using the first spatial-domain filter. In an example, based on using the first spatial-domain filter, the WTRU may receive a second DCI and a PDSCH (e.g., RRC setup message, e.g., Msg4) scheduled by the second DCI.

The WTRU may transmit an ACK (e.g., Msg5) in response to the RRC setup message by using the second spatial-domain filter. In an example, based on using the second spatial-domain filter, the WTRU may transmit a second PUSCH (e.g., Msg5) or an associated UL transmission, indicated by the PDSCH (e.g., Msg4).

Multiple SSBs may be pre-associated with an SSB. The WTRU may determine a first spatial-domain filter being used for reception of a first SSB (e.g., that may be SSB #1), based on the pre-associations configured as follows. Examples of pre-associations may include: SSB #2 (transmitted from DL-TRP1) and one or more second SSB indexes, e.g., SSB #4 (representing a geographically-separated UL-TRP2), where each of the one or more second SSB indexes may be mapped to a separate RO. Examples of pre-associations may include SSB #1 (transmitted from DL-TRP 1) and one or more fourth SSB indexes, e.g., SSB #2, 3, 11, 12 (for UL-TRP 2), where each of the one or more fourth SSB indexes may be mapped to a separate RO.

Examples of SSB-to-RO mapping may be provided (e.g., based on the information on pre-associations such as SSB #1 being pre-associated with SSB #2, 3, 11, 12 (for UL-TRP 2) each being mapped to a separate RO, with M=2, K=16). The examples of SSB-to-RO mapping may include SSB #1 maps to RO #1&2 (pre-associated with SSB #2), RO #3&4 (pre-associated with SSB #3), RO #5&6 (pre-associated with SSB #11), and RO #7&8 (pre-associated with SSB #12). The examples of SSB-to-RO mapping may include SSB #2 maps to RO #9&10 (pre-associated with SSB #4). The examples of SSB-to-RO mapping may include SSB #3 maps to at least RO #11&12 (pre-associated with at least SSB #X, where X may be 3, e.g., based on the default association). The examples of SSB-to-RO mapping may include SSB #4 maps to at least RO #13&14 (pre-associated with at least SSB #Y, where Y may be 4, e.g., based on the default association).

The WTRU may determine, based on the pre-associations, the one or more second SSB indexes (e.g., SSB #2, 3, 11, 12) being associated with the detected first SSB index (e.g., SSB #1). The WTRU may determine a second, third, fourth, and fifth spatial-domain filter associated with (e.g., being used for receiving or measuring) the SSB #2, 3, 11, and 12, respectively.

The WTRU may determine, based on the SSB-to-RO mapping and the pre-associations, total 8 ROs such as RO #1&2 (pre-associated with SSB #2), RO #3&4 (pre-associated with SSB #3), RO #5&6 (pre-associated with SSB #11), and RO #7&8 (pre-associated with SSB #12).

The WTRU (in response to detecting the SSB #1) may transmit one or more PRACHs (e.g., up to (all or a subset of) 8 PRACHs corresponding to the total 8 ROs). In an example, the WTRU may determine to transmit 8 PRACHs corresponding to the total 8 ROs, e.g., unless one or more validity conditions are determined as failed (e.g., when a subset of ROs are overlapped with other (higher-priority) resources or signals (e.g., a type of UCI, RS) or the subset of ROs are outside of a UL subband, etc).

The WTRU may determine a first PRACH Tx power based on the associated PL-offset parameter(s) (e.g., PL-offset #5 associated with the SSB #2, being pre-associated with SSB #1) and/or the one or more PRACH power control related parameters. The WTRU may determine a second PRACH Tx power based on the associated PL-offset parameter(s) (e.g., PL-offset #6 associated with the SSB #3, being pre-associated with SSB #1) and/or the one or more PRACH power control related parameters. The WTRU may determine a third PRACH Tx power based on the associated PL-offset parameter(s) (e.g., PL-offset #9 commonly associated with the SSB #11&12, being pre-associated with SSB #1) and/or the one or more PRACH power control related parameters.

The WTRU may transmit a first PRACH on the determined RO(s) such as RO #1&2 (mapped from SSB #2) by using the determined first PRACH Tx power (based on PL-offset #5) and the second spatial-domain filter.

The WTRU may transmit a second PRACH on the determined RO(s) such as RO #3&4 (mapped from SSB #3) by using the determined second PRACH Tx power (based on PL-offset #6) and the third spatial-domain filter.

The WTRU may transmit a third PRACH on the determined RO(s) such as RO #5&6 (mapped from SSB #11) by using the determined third PRACH Tx power (based on PL-offset #9) and the fourth spatial-domain filter.

The WTRU may transmit a fourth PRACH on the determined RO(s) such as RO #7&8 (mapped from SSB #12) by using the determined third PRACH Tx power (commonly based on PL-offset #9) and the fifth spatial-domain filter.

The WTRU may receive a random-access response (RAR) (e.g., Msg2, transmitted from the DL-TRP1, e.g., on either the 1st or 2nd DL subband) by using the first spatial-domain filter, where the RAR may comprise a scheduling grant for a PUSCH transmission. In examples, the WTRU may receive a DCI and the RAR scheduled by the DCI. The RAR may include a RA preamble identifier (matched to the transmitted PRACH), a temporary C-RNTI (TC-RNTI), a timing advance command, a UL grant of the PUSCH (Msg3) for WTRU to transmit, and/or one or more parameters indicating which transmitted PRACH(s) and/or which RO(s) are the RAR is referring (e.g., responding, pointing) to, which may indicate the RO #5 and/or RO #6 (and/or the third PRACH) as an example. The one or more parameters indicating the RO #5 and/or RO #6 (and/or the third PRACH) may be based on that a received quality of the third PRACH at the BS may be above a threshold at the BS but other received quality of PRACHs (e.g., the first, second, and fourth PRACHs) may be below the threshold at the BS. The one or more parameters may comprise a RO-selector (field) (or RO-indicator (field)). The one or more parameters may comprise a PRACH-selector (field) (or PRACH-indicator (field)).

Based on the RAR, e.g., selecting the RO #5 and/or RO #6 (and/or the third PRACH), the WTRU may transmit the PUSCH (e.g., Msg3, toward the UL-TRP2) by using the fourth spatial-domain filter, e.g., where the WTRU may determine a valid resource for the PUSCH is within the 1st UL subband. The WTRU may receive a RRC setup message (e.g., Msg 4, transmitted from the DL-TRP1, on either the 1st or 2nd DL subband) by using the first spatial-domain filter. The WTRU may transmit an ACK (e.g., Msg5), for example, in response to the RRC setup message by using the fourth spatial-domain filter.

Zone-based RO selection may be provided. For example, a WTRU may select an RO based on a zone associated with the WTRU.

In examples, the WTRU may determine a first spatial-domain filter being used for reception of a first SSB (e.g., that may be SSB #1), based on the pre-associations configured as follows, e.g., including configurations for “Zone-based RO selection”.

Examples of pre-associations may include SSB #1 (transmitted from DL-TRP1) and one or more fourth SSB indexes, e.g., SSB #2, 3, 11, 12 (for UL-TRP 2), where each of the one or more fourth SSB indexes may be mapped to a separate RO.

Examples of pre-associations may include SSB #2 being further associated with a case when the WTRU determines the WTRU's location (positioning) is based on Zone A (being pre-defined or pre-configured).

Examples of pre-associations may include SSB #3 being further associated with a case when the WTRU determines the WTRU's location (positioning) is based on Zone B (being pre-defined or pre-configured).

Examples of pre-associations may include SSB #11&12 being further associated commonly with a case when the WTRU determines the WTRU's location (positioning) is based on Zone C (being pre-defined or pre-configured).

Examples of SSB-to-RO mapping (e.g., based on the information on pre-associations such as SSB #1 being pre-associated with SSB #2, 3, 11, 12 (for UL-TRP 2) each being mapped to a separate RO, with M=2, K=16) may include SSB #1 maps to RO #1&2 (pre-associated with SSB #2), RO #3&4 (pre-associated with SSB #3), RO #5&6 (pre-associated with SSB #11), and/or RO #7&8 (pre-associated with SSB #12).

The WTRU may determine, based on the pre-associations, the one or more second SSB indexes (e.g., SSB #2, 3, 11, 12) being associated with the detected first SSB index (e.g., SSB #1). The WTRU may determine a second, third, fourth, and fifth spatial-domain filter associated with (e.g., being used for receiving or measuring) the SSB #2, 3, 11, and 12, respectively.

The WTRU may determine the WTRU's (current) location is associated with Zone A, e.g., based on an outcome from a (configured) positioning procedure such as Uplink Time Difference of Arrival (UTDOA), Observed Time Difference of Arrival (OTDOA), Global Navigation Satellite System(GNSS)-based positioning method, etc.

Based on the determined WTRU's location (e.g., as Zone A), the SSB-to-RO mapping, and/or the pre-associations, the WTRU may determine (e.g., select) RO #1 and/or RO #2 (e.g., associated with SSB #2 and Zone A) out of the total 8 ROs associated with SSB #2, 3, 11, 12 (e.g., pre-associated with the detected SSB #1).

The WTRU (e.g., in response to detecting the SSB #1) may transmit a first PRACH (e.g., corresponding to the selected RO #1) and/or a second PRACH (e.g., corresponding to the selected RO #2), e.g., unless one or more validity conditions are determined as failed (e.g., when a subset of ROs are overlapped with other (e.g., higher-priority) resources or signals (e.g., a type of UCI, RS) or the subset of ROs are outside of a UL subband, etc).

The WTRU may determine a first PRACH Tx power based on the associated PL-offset parameter(s) (e.g., PL-offset #5 associated with the SSB #2, being pre-associated with SSB #1) and/or the one or more PRACH power control related parameters. The WTRU may transmit the first PRACH on the determined RO(s) such as RO #1&2 (e.g., mapped from SSB #2) by using the determined first PRACH Tx power (e.g., based on PL-offset #5) and the second spatial-domain filter.

The WTRU may receive a random-access response (RAR) (e.g., Msg2, transmitted from the DL-TRP1, e.g., on either the 1st or 2nd DL subband) by using the first spatial-domain filter, where the RAR may comprise a scheduling grant for a PUSCH transmission. In an example, the WTRU may receive a DCI and the RAR scheduled by the DCI, where the RAR may comprise a RA preamble identifier (e.g., matched to the transmitted PRACH), a temporary C-RNTI (TC-RNTI), a timing advance command, a UL grant of the PUSCH (Msg3) for WTRU to transmit, and/or one or more parameters indicating which transmitted PRACH(s) and/or which RO(s) are the RAR is referring (e.g., responding, pointing) to.

Based on the RAR, e.g., indicating the RO #1 and/or RO #2, the WTRU may transmit the PUSCH (e.g., Msg3, toward the UL-TRP2) by using the second spatial-domain filter, e.g., where the WTRU may determine a valid resource for the PUSCH is within the 1st UL subband. The WTRU may receive a RRC setup message (e.g., Msg4, transmitted from the DL-TRP1, on either the 1st or 2nd DL subband) by using the first spatial-domain filter. The WTRU may transmit an ACK (e.g., Msg5) in response to the RRC setup message by using the second spatial-domain filter.

The WTRU may receive a configuration of (pre-)associations from a base station. For example, a WTRU may be configured with a message (e.g., (pre-)associations between first SSB index and second SSB index for separated TRP or mapping rule between parameters for initial attempt and re-attempt) via an RRC SIB (e.g., cell-specific) message and/or RRC dedicated message (e.g., per WTRU) which transmitted by base station. For example, a WTRU may be configured with a list or multiple (pre-)associations, then the WTRU may activate one of the (pre-)associations upon receiving an indication of activation (e.g., via DCI, MAC CE, RRC message).

In examples, a WTRU may transmit assistance information for determining/reconfiguration of (pre-)association information to a network. The assistance information may include a geographical location (e.g., absolute/relative location, current location zone) and/or detecting cell ID(s)/TRP ID(s) and/or measurement results of DL-RSRP value with one or more SSB indices of the cell(s)/TRP(s) and/or WTRU mobility information (e.g., direction) and/or current (pre-)association information (e.g., RACH occasion ROs) and/or a number of failure information in the previous attempt with the selected ROs and/or determined PRACH power with TX power level.

In examples, as a triggering/activating condition, if the WTRU failed with a number of PRACH transmissions with one of the SSB index and/or if the WTRU failed a number of PRACH transmission with a certain TX power level, the WTRU may trigger to send a request of update/reconfiguration with the (pre-)association via transmitting UCI, MAC CE, RRC message to a base station.

In examples, a WTRU may be reconfigured with a reconfiguration message (e.g., RRC SIB and/or dedicated RRC message) and/or a WTRU may determine to perform reconfiguration if at least one of the following conditions is satisfied. For example, the WTRU may determine to perform reconfiguration upon transmitting the assistance information, upon detecting the number of failure PRACH attempt, upon performing the handover procedure, and/or upon performing the cell reselection procedure.

For example, the reconfiguration message for (pre-)association may comprise new (pre-)association information (e.g., (pre-)association between SSB indices and/or TRP ID(s) and/or carrier ID(s)) and/or an indication of activation of (pre-)association among the configured (pre-)associations.

For example, upon detecting the number of failure PRACH attempt, a WTRU may be re-configured with a reconfiguration message (e.g., RRC SIB and/or dedicated RRC message). The reconfiguration message may comprise a new (pre-)association information (e.g., (pre-)association between SSB indices and/or TRP ID(s) and/or carrier ID(s)) and/or an indication of activation of (pre-)association among the configured (pre-)associations.

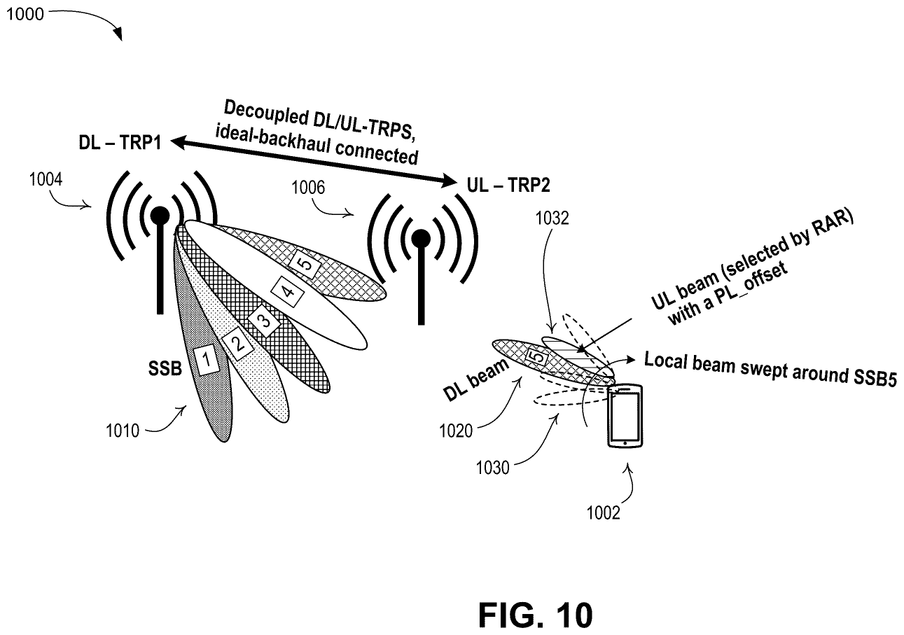

FIG. 10 depicts an example WTRU beam sweeping 1000 based on associations between an SSB 1020 and a set of ROs. For example, a WTRU 1002 may perform the beam sweeping 1000 based on associations between an SSB 1020 (e.g., transmitted by DL-TRP1 1004) and/or a set of ROs.

The WTRU 1002 may receive a (pre)configuration, e.g., received from the network using SIB, to perform multiple PRACH transmissions associated with a given SSB detection for the Random Access procedure in the decoupled TRPs scenario. The WTRU 1002 may receive, in addition, replacement, or combination with the previously described parameters, one or more of the following parameters, for each of the configured SSB 1010.

The WTRU 1002 may receive at least one set of ROs, each set of ROs being associated with one SSB. For example, the WTRU 1002 may receive a set of resources, including multiple ROs configured across multiple time resources. The resources may be configured to be consecutive in the time domain, e.g., using consecutive symbols/slots. The ROs may be indexed, e.g., the index is received with the RO configuration, or the WTRU 1002 may infer the index from the order of the received configuration, or the index is inferred from the order in the time domain where the resources are located.

The WTRU 1002 may receive a transmission beam configuration indicating how the WTRU 1002 may transmit the PRACH in the ROs associated with a given SSB 1020. The transmission beam configuration may indicate a WTRU beam sweeping. The WTRU 1002 may transmit the different PRACH using different transmission beams 1030, without a specific beam indication from the network. The WTRU 1002 may determine to use a set of transmission beams 1030, e.g., based on the received SSB(s), based on a pre-configured set of transmission beams, based on beams whose direction are close to the direction of the reception of the SSB(s) 1010, etc. This may be configured by the network when the correlation between the DL-TRP beams 1010 and UL-TRP beams cannot be ensured to the WTRU 1002 and/or a larger beam sweeping may be required to find a good beam correspondence.

The transmission beam configuration may indicate a WTRU sweeping with an associated set of DL beams (e.g. subset), e.g., based on at least one embodiment based on the aforementioned pre-associations between SSBs. The WTRU 1002 may be configured to transmit over the different ROs using a received set of transmission beams, e.g., the transmit beams corresponding to the receive beams of a (sub)set of the SSBs. This may be configured by the network when an uncertain correlation is assumed between the DL-TRP beams 1010 and UL-TRP beams for the WTRU 1002.

The transmission beam configuration may indicate no WTRU beam sweeping. The WTRU 1002 may be configured not to perform beam sweeping when the DL and UL TRPs 1004, 1006 are co-located or quasi-co-located. For example, the WTRU 1002 may assume that the transmission beam and received beam are the same (e.g., same direction). The network may have configured a single or multiple ROs, e.g., for redundancy. The WTRU 1002 may also be configured so that the network (e.g., the UL TRP 1006) is the one performing the beam-sweeping, e.g., using different reception beams. The WTRU 1002 may repeat the transmission of the PRACH over the different ROs using the same beam to ease the network's measurements. The beam to use may be indicated by the network, e.g., using a (pre)configured association between the DL TRP SSB 1020 and the associated transmission beam. For example, using the same beam for transmission and reception. In another example, using a mapping with another beam (e.g., based on at least one embodiment based on the pre-associations between SSBs).

The transmission beam configuration may indicate a joint beam sweeping. The WTRU 1002 may be (pre)configured to transmit on different ROs with different beams, where an indication may indicate which ROs have repeated beam transmissions, and which are different. The indication may be a time pattern (e.g., change every X ROs, repeated all the beams, etc.). The WTRU 1002 may receive such configuration to allow both the UL TRP 1006 and the WTRU 1002 to have a joint beam-sweeping, to be able to identify the right combination of transmission/reception beams at the UL TRP side. The WTRU 1002 may be configured with multiple transmission configurations, and the WTRU 1002 may determine which to use, e.g., based on its local information. For example, the WTRU 1002 may determine which transmission configuration to use based on WTRU position and/or receptions/measurements on the SSB 1020. In examples, the WTRU 1002 may be configured with positions/areas for which the WTRU 1002 may use a first configuration, and another position/area for which to use another configuration. For instance, based on distance to the network TRPs 1004, 1006.

The WTRU 1002 may determine whether the signal to the DL TRP 1004 is line-of-sight(LOS) or non-LOS(NLOS) and determine to use a first configuration when LOS and another configuration when NLOS. In another example, the WTRU 1002 may be configured with a pathloss threshold from the SSB measurement(s) that indicate whether to use a first (e.g., below the threshold) or a second (e.g. above the threshold) configuration.

The WTRU 1002 may, based on the received (pre)configuration, determine the transmission beam(s) (e.g., towards the UL-TRP2 1006) to use for each RO, associated with a detected SSB (e.g., using a reception beam based on-e.g. a DL beam #5 as illustrated in FIG. 10). The WTRU 1002 may perform the transmission using the determined beams and, e.g., using any pathloss/power control indication/determination, similarly as previously described, e.g., based on the configured PL-offset parameter(s).

The WTRU 1002 may then monitor for a network response to the transmitted PRACH, e.g., monitoring for RAR within a configured RAR window after the transmission of the PRACH.

The WTRU 1002 may determine the receiver beam to use, which may be the same as the one used to receive the SSB of the associated ROs, e.g., SSB #5 in FIG. 10.

The WTRU 1002 may be configured to monitor one or more RAR(s) associated with the detected SSB, e.g., associated with the corresponding transmitted ROs. For example, the WTRU 1002 may receive a configuration (e.g., configuration information) indicating one or more of the following. The configuration information may indicate a RAR number, e.g., how many (e.g., maximum) RAR messages the WTRU may receive for a given detected SSB. The configuration information may include a control channel resource (e.g., The CORESET #0) corresponding to the PDCCH resources for the reception of the multiple RAR messages. The resources may be consecutive in time and/or ordered with some implicit or explicit indexes. For instance, each symbol may be associated with a different RAR message. The configuration information may include an RA-RNTI used to decode the RAR PDCCH.

The WTRU 1002 may receive one or more RARs in the monitored RAR window. The WTRU 1002 may determine which PRACH/and/or RO is associated with the received RAR based on an explicit indication or an implicit indication. For example, the WTRU 1002 may determine which PRACH and/or RO is associated with the received RAR based on an indication in the RAR message of the corresponding RO and/or PRACH (e.g., index). For example, the WTRU 1002 may determine which PRACH and/or RO is associated with the received RAR based on the resource on which the RAR was received. The WTRU 1002 may determine the PRACH/and/or RO associated with the RAR based on the time resource e.g., index/number of the symbol used for RAR.

The WTRU 1002 may determine the (default) transmission beam 1032 to use to transmit to the UL-TRP 1006 using the transmit beams 1030 used for the transmission of the PRACH and/or RO associated with the received RAR.

WTRU beam sweeping may be performed using associations between an SSB and a set of ROs. A WTRU may receive information on associations (e.g., signaled by SIB) between an SSB index (transmitted by DL-TRP1) and a set of ROs (e.g., spanned across consecutive time units), where a WTRU may transmit PRACH(s) on at least one of the set of ROs by applying “local-beam sweeps” around the SSB index. The local-beam sweeps may provide benefits in terms of opportunistically targeting a beam direction toward the UL-TRP2 which is geographically-separated from the DL-TRP1 (in the asymmetric DL/UL TRP scenario).

The WTRU may detect the first SSB index (transmitted from the DL-TRP1), e.g., within a DL subband configured for the DL-TRP1, when a FD (e.g., SBFD) operation is enabled. The WTRU may transmit PRACH(s) (toward the UL-TRP2), e.g., by applying such local-beam sweeping within a UL subband configured for the UL-TRP2. The network (e.g., DL-TRP1, BS, cell, node) may transmit one or more RARs within a RAR window. The WTRU may (be configured to) monitor (via CORESET #0) a RAR by using the (same) SSB (e.g., SSB #5 in FIG. 9). Based on a RA-RNTI (used in the RAR PDCCH), e.g., based on symbol index/number, the WTRU may determine (or receive) an implicit indication of which RO (local-swept PRACH) is selected by the network (e.g., at UL-TRP2).

The WTRU may receive a first RAR indicating one of the multiple transmitted PRACHs (local beam swept) each corresponding to an RO of the set of ROs. On condition that the WTRU receives (e.g., only receives) the first RAR (e.g., within a DL subband of DL-TRP1), the WTRU may transmits a PUSCH (Msg3) (e.g., within a UL subband of UL-TRP2) by using the same beam applied on the PRACH transmission on the one indicated RO of the set and by using a PL offset (e.g., if indicated by the RAR). In an example, a second PL offset may be associated with a second RO of the set where the one indicated RO and the second RO may be associated (e.g., tagged) each other under a same UL beam constraint, e.g., where only different PL offsets such as one larger and one smaller PL-offset may be applied across the different ROs, to opportunistically target a proper PRACH Tx power level to be receivable at the UL-TRP2).

In examples, the WTRU may receive a second RAR (within the same RAR window) indicating a second one of the multiple transmitted PRACHs (local beam swept) corresponding to a second RO of the set of ROs. The WTRU may operate based on a UL transmission scheme (e.g., being configured or indicated, such as coherent-joint-reception (CJR), simultaneous Tx across multiple WTRU-panels (STxMP), etc.) by using a first beam direction corresponding to the first transmitted PRACH on the RO and a second beam direction corresponding to the second transmitted PRACH on the second RO. The indicated PRACH(s) (by RAR) corresponding to the indicated RO and/or the second RO (of the set of ROs) may be (e.g., become) by default source-QCL RS(s) of a TCI state (e.g., a TCI-state and/or a UL-TCI-state). In an example, in response to receiving the indicated RO and/or the second RO), the TCI state may (e.g., automatically) include an RO index (and/or a corresponding transmitted PRACH index) as being a QCL reference, e.g., instead of a DL-RS such as SRS, SSB, CSI-RS as source-QCL, where the QCL reference may be further used for subsequent scheduled reception or transmission of a channel or signal where the applicable physical channel or signal (or one or particular types of a physical channel or signal) may be at least one of the following.

The applicable physical channel or signal may be a PUSCH (e.g., all types of PUSCH, or one or more particular types of PUSCH). The PUSCH may be a configured grant(CG)-PUSCH (or further specific to a particular Tx type, e.g., a Type-1 CG-PUSCH, a Type-2 CG-PUSCH, etc.) or a dynamic grant (DG) PUSCH. The applicable physical channel or signal may be a PUCCH (e.g., all types of PUCCH, or one or more particular types of PUCCH). For example, the PUCCH may be a PUCCH carrying CSI reporting contents (e.g., a PUCCH carrying a UCI) or a PUCCH carrying a HARQ-ACK. The applicable physical channel or signal may be an SRS (e.g., all types of SRS, or one or more particular types of SRS). For example, the SRS may be an SRS resource, an SRS resource set, an SRS configuration (e.g., ‘SRS-config’) that may comprise one or more SRS resource sets (e.g., or, one or more SRS resources), and/or a group of SRS resources associated with a (e.g., same) ‘usage’ parameter, e.g., indicating at least one of {CB, NCB, BM, AS}. The applicable physical channel or signal may be a PRACH (e.g., all types of PRACH, or one or more particular types of PRACH). The PRACH may be a group of PRACHs, associated with (e.g., used for) a contention-based random access (or a contention-free random access) or a group of PRACHs, associated with (e.g., used for) a 4-step RACH procedure (or a 2-step RACH procedure). The applicable physical channel or signal may be a PDSCH (e.g., all types of PUSCH, or one or more particular types of PUSCH). A PDSCH may be a semi-persistent-scheduling(SPS)-PDSCH (or further specific to a particular type of SPS-PDSCH, if configured) or a dynamic grant (DG) PDSCH.

The applicable physical channel or signal may be a PDCCH (and/or CORESET) (e.g., all types of PDCCH (and/or CORESET), or one or more particular types of PDCCH (and/or CORESET)). For example, the PDCCH may be a group of PDCCH types, a group of cell-common PDCCHs (e.g., that may be associated with a cell-specific search space (set)), a group of WTRU-specific PDCCHs (e.g., that may be associated with a WTRU-specific search space (set)), a PDCCH associated with a particular group of search spaces (or search space sets), or a PDCCH associated with a particular group of CORESETs (e.g., a special CORESET, CORESET #0, CORESET #0 that may be used for initial access, a CORESET that is configured as a part of beam failure recovery procedure). The applicable physical channel or signal may be a CSI-RS (e.g., all types of CSI-RS, or one or more particular types of CSI-RS). The CSI-RS may be a CSI-RS resource, a CSI-RS resource set, a CSI-RS configuration (e.g., ‘CSI-RS-config’) that may comprise one or more CSI-RS resource sets (or, one or more CSI-RS resources), a group of CSI-RS resources associated with a (e.g., same) particular usage, e.g., applicable for beam management, mobility management, and/or RRM, etc., or a group of CSI-RS resources for tracking (e.g., tracking RS (TRS)).

The applicable physical channel or signal may be a demodulation RS (DMRS) (e.g., all types of DMRS, or one or more particular types of DMRS). The applicable physical channel or signal may be a phase-tracking RS (PTRS) (e.g., all types of PTRS, or one or more particular types of PTRS).

1. A wireless transmit/receive unit (WTRU) comprising:
a memory and a processor, wherein the processor is configured to:
receive a first synchronization signal block (SSB) from a first transmission reception point (TRP);
receive configuration information associated with the first TRP, wherein the configuration information indicates pre-associations between a plurality of first SSBs associated with the first TRP and a plurality of second SSBs associated with a random access procedure;
determine to use one or more SSBs of the plurality of second SSBs for the random access procedure based on the pre-associations;
send a random access message to a second TRP using a second SSB of the determined one or more SSBs; and
receive a random access response (RAR) message from the first TRP that indicates a scheduling grant for a physical uplink shared channel (PUSCH) transmission.

2. The WTRU of claim 1, wherein the configuration information further indicates mapping information between the plurality of second SSBs and respective pathloss (PL) offset parameters associated with sending the random access message.

3. The WTRU of claim 2, wherein the processor is further configured to determine a transmit power level for the random access message based on a PL offset associated with the second SSB.

4. The WTRU of claim 1, wherein the configuration information further indicates mapping information between the plurality of second SSBs and respective random access channel (RACH) occasions (ROs).

5. The WTRU of claim 1, wherein the processor is further configured to determine a first spatial-domain filter associated with reception of the first SSB.

6. The WTRU of claim 5, wherein the processor is further configured to determine a second spatial-domain filter associated with receiving the second SSB.

7. The WTRU of claim 1, wherein the pre-associations comprise a pre-association between the first SSB and one or more SSBs of the plurality of second SSBs.

8. The WTRU of claim 1, wherein the configuration information is received from the first TRP via a system information block (SIB).

9. The WTRU of claim 1, wherein the configuration information comprises first time and frequency location information on one or more downlink subbands in one or more subband non-overlapping full duplex (SBFD) slots or time and frequency location information associated with one or more uplink subbands in the one or more SBFD slots.

10. The WTRU of claim 1, wherein the random access message is sent using a plurality of second SSBs on a plurality of uplink beams with respective directions that are proximate to a direction of the downlink beam associated with the first SSB, and wherein the RAR message indicates a selection of one of the plurality of uplink beams to use for the PUSCH transmission.

11. A method performed by a wireless transmit/receive unit (WTRU), the method comprising:
receiving a first synchronization signal block (SSB) from a first transmission reception point (TRP);
receiving configuration information associated with the first TRP, wherein the configuration information indicates pre-associations between a plurality of first SSBs associated with the first TRP and a plurality of second SSBs associated with a random access procedure;
determining to use one or more SSBs of the plurality of second SSBs for the random access procedure based on the pre-associations;
sending a random access message to a second TRP using a second SSB of the determined one or more SSBs; and
receiving a random access response (RAR) message from the first TRP that indicates a scheduling grant for a physical uplink shared channel (PUSCH) transmission.

12. The method of claim 11, wherein the configuration information further indicates mapping information between the plurality of second SSBs and respective pathloss (PL) offset parameters associated with sending the random access message.

13. The method of claim 12, further comprising determining a transmit power level for the random access message based on a PL offset associated with the second SSB.

14. The method of claim 11, wherein the configuration information further indicates mapping information between the plurality of second SSBs and respective random access channel (RACH) occasions (ROs).

15. The method of claim 11, further comprising determining a first spatial-domain filter associated with reception of the first SSB.

16. The method of claim 15, further comprising determining a second spatial-domain filter associated with receiving the second SSB.

17. The method of claim 11, wherein the pre-associations comprise a pre-association between the first SSB and one or more SSBs of the plurality of second SSBs.

18. The method of claim 11, wherein the configuration information is received from the first TRP via a system information block (SIB).

19. The method of claim 11, wherein the configuration information comprises first time and frequency location information on one or more downlink subbands in one or more subband non-overlapping full duplex (SBFD) slots or time and frequency location information associated with one or more uplink subbands in the one or more SBFD slots.

20. The method of claim 11, wherein the random access message is sent using a plurality of second SSBs on a plurality of uplink beams with respective directions that are proximate to a direction of the downlink beam associated with the first SSB, and wherein the RAR message indicates a selection of one of the plurality of uplink beams to use for the PUSCH transmission.
